(19) United States
(12) Patent Application Publication
(10) Pub. No.: US 2024/0352384 A1
(43) Pub. Date: Oct. 24, 2024

(54) LAUNDRY SANITIZING COMPOSITIONS

(71) Applicant: Reckitt Benckiser LLC, Parsippany, NJ (US)

(72) Inventors: Marcella BONESSO, Mira (IT); Andre CHIEFFI, Mira (IT); Giulia COLLEDAN, Mira (IT); Joseph Fredrick CONVERY, II, Montvale, NJ (US); Anna DEL MONACO, Mira (IT); Santigie MANSARAY, Montvale, NJ (US); Remigio MUSCI, Mira (IT); Federico PACINI, Mira (IT); Benjamin Aaron PEARL, Montvale, NJ (US); Antonio Vincenzo PETROZZINO, Montvale, NJ (US); Tracy Ann RYAN, Montvale, NJ (US); Anna Kepa SIGMUND, Montvale, NJ (US); Alberto SIMIONATO, Mira (IT); Alessandra TRAVANUT, Mira (IT); Elisa VANZETTO, Mira (IT); Stephanie Kaitlyn YIU, Montvale, NJ (US); Carrie Ann ROMANOV, Montvale, NJ (US); Olivia CRAIN, Montvale, NJ (US); Cori Ann ZAZULKA, Montvale, NJ (US)

(21) Appl. No.: 18/641,691

(22) Filed: Apr. 22, 2024

Related U.S. Application Data
(63) Continuation-in-part of application No. 18/304,584, filed on Apr. 21, 2023.

(51) Int. Cl. C11D 3/48; C11D 1/72; C11D 1/75; C11D 1/90; C11D 1/92; C11D 1/94; C11D 3/20; C11D 3/22; C11D 3/30; C11D 3/50; C11D 11/00

(52) U.S. Cl. CPC C11D 3/48; C11D 1/94; C11D 3/2068; C11D 3/2086; C11D 3/225; C11D 3/30; C11D 3/505; C11D 11/0094; C11D 1/72; C11D 1/75; C11D 1/90; C11D 1/92

(57) ABSTRACT

Liquid laundry products comprising containers comprising liquid laundry compositions are disclosed. The liquid laundry compositions comprise approximately 2% wt to approximately 8% wt of a benzyl-substituted quaternary ammonium compound and score 75 or less under Test 437 from Organisation for Economic Cooperation and Development (OECD) titled Bovine Corneal Opacity and Permeability Test Method for Identifying Ocular Corrosives and Severe Irritants. As a result, the disclosed liquid laundry products do not require child-resistant packaging under 40 C.F.R. § 157, subpart B.

### PRIORITY DATA

This application is a continuation-in-part of U.S. patent application Ser. No. 18/304,584 filed Apr. 21, 2023, the contents of which are incorporated by reference herein in its entirety.

### TECHNICAL FIELD

Liquid laundry products comprising containers comprising liquid laundry compositions are disclosed. The liquid laundry compositions comprise approximately 2% wt to approximately 8% wt of a benzyl-substituted quaternary ammonium compound and score 75 or less under Test 437 from Organisation for Economic Cooperation and Development (OECD) titled Bovine Corneal Opacity and Permeability Test Method for Identifying Ocular Corrosives and Severe Irritants. As a result, the disclosed liquid laundry products do not require child-resistant packaging under 40 C.F.R. § 157, subpart B.

### BACKGROUND

Consumers have increased interest in washing laundry under energy and water efficient conditions due to environmental concerns. Consumers also have increased interest in washing with reduced environmental impact. For example, some consumers use less environmentally harmful laundry detergents and fabric softeners. Consumers are also interested in washing laundry at cooler temperatures, with less water, and with milder laundry formulations. Washing laundry under these conditions raises concerns that the resulting items may be visibly clean but may be unhygienic because they may still harbor pathogens. Therefore, there is a growing demand for laundry sanitizing compositions to ensure that clean laundry harbors fewer pathogens. However, laundry sanitizing compositions are added to the fabric softener drawer of the washing machine, making it difficult to use both laundry sanitizing compositions and fabric softener compositions in the same wash cycle.

Lysol® Laundry Sanitizer (LLS) is a commercially available product that is used for sanitizing clean laundry. LLS contains the dialkyl (C₈₋₁₀) dimethylammonium chloride (DDAC), benzyl-C₁₂₋₁₈-alkyldimethyl ammonium chloride (ADBAC), and an alcohol alkoxylate nonionic surfactant. About 150 mL of LLS is added to the fabric softener drawer of the top-load washing machine for use in the washing machine rinse cycle (100 mL is added for front-loaders). LLS kills 99.9% of bacteria (i.e., a 3-log₁₀ reduction in bacteria) in laboratory tests (e.g., ASTM 2274).

WO2023/036940 to Rhodia Operations discloses an antimicrobial composition comprising a first antimicrobial agent selected from the group consisting of benzalkonium salts, trilocarban, diclosan, triclosan, or combinations thereof, and a second antimicrobial agent which is a cationic polymer (known as polyquaternium 2) having a weight average molecular weight of 1,000 to 50,000 represented by the general formula (1):

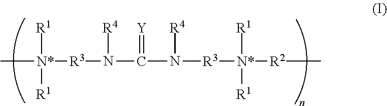

US2022/233411 to Godrej Consumer Products Ltd discloses a reconstitutable sanitizer formulation which is non-alcoholic in nature and achieves up to 99.9% reduction in microbial load and provides long-lasting protection against microbes for 2-6 hours.

WO2021/156297 to Arch UK Biocides Ltd discloses laundry sanitizing compositions containing a biocide agent and an acidic buffering system.

WO2020/168046 to Rhodia Operations discloses microbial compositions that include an antimicrobial component having at least one quaternary ammonium compound; a synthetic polymer, such as PQ5, PQ7, PQ11, or PQ28; an organic acid; a surfactant selected from cationic surfactants, amphoteric surfactants, and combinations thereof; and at least one non-ionic surfactant.

WO2019/015839 to Henkel AG & Co. KGAA discloses aqueous cleaning agents comprising at least one cationic surfactant comprising at least one quaternary ammonium compound, at least one nonionic surfactant comprising at least one amine oxide, at least one alcohol, optional additives, and water.

WO2018/108466 to Unilever PLC discloses a biocidal composition comprising one or more water soluble quaternary ammonium compounds and one or more water soluble organic hydroxy acids. 2 to 100 mL of the composition is added to the rinse aid dispenser of an automatic washing machine, optionally together with a dose of liquid fabric conditioner in the same dispensing compartment.

WO2014/092693 to Colgate-Palmolive Company discloses a composition comprising a cationic surfactant and an esterquat that is a quaternized reaction product of an alkanol amine and a fatty acid wherein from at least 90 wt % to up to 100 wt % of the esterquat is comprised of triesterquat and from 0 wt % to up to 10 wt % of the esterquat is comprised of at least one of monoesterquat and diesterquet. The composition may be used to soften fabric or increase fragrance delivery.

WO2013/124784 to BASF (China) Company Limited discloses compositions comprising a) an antimicrobial agent selected from the group consisting of biocides containing halogen atoms and/or containing phenolic moieties, formic acid, chlorine dioxide, chlorine dioxide generating compounds, dialdehydes, components containing an antimicrobial metal, such as antimicrobial metal, and b) a polymine, especially polyethyleneimine.

WO2013/017967 to Kimberly-Clark Worldwide Inc. discloses antimicrobial cleansing compositions including a polar carrier solvent, a cationic compatible surfactant, a quaternary ammonium biocide, and a cationic compatible afterfeel agent.

WO2012/090100 to Kimberly-Clark Worldwide, Inc. discloses durable antimicrobial compositions comprising a carbonate/bicarbonate salt of a quaternary ammonium cation, an organic acid, hydrogen peroxide and a cationic polymer.

WO2012/080918 to Ecolab USA Inc discloses anti-microbial compositions comprising a quaternary ammonium compound and a cationic biocide.

WO2011/149475 to Colgate-Palmolive Company discloses a composition comprising an esterquat that is a quaternized reaction product of an alkanol amine and a fatty acid. Methods of softening fabric and increasing fragrance delivery by treating fabric with the compositions are also disclosed.

WO2007/104387 to Hindustan Unilever Ltd discloses a fabric conditioner composition comprising 0.1-20% by weight cationic fabric conditioner active, 0.1-10% organic acid having 1 to 8 carbon atoms, and 0.1-5% anion quencher selected from a mono-long chain quaternary ammonium compound having the formula R(R¹)₃N⁺X⁻, wherein R is C8-22 alkyl or alkenyl, R¹ is a C1-C3 alkyl, and X⁻ is an anionic selected from chloride, bromide iodide, nitrate, sulfate, methyl sulfate, ethyl sulfate, acetate, ad phosphate, or an alkyl benzyl quaternary ammonium compound having the formula R²R³(R⁴)₂N⁺X⁻, wherein R² is a C6-18 alkyl or alkenyl group, R³ is a benzyl group, and R⁴ is a C1-C3 alkyl group.

WO2006/094582A1 to Unilever PLC discloses aqueous fabric softening compositions having good high temperature stability comprising a cationic fabric softening compound and water soluble polysaccharide polymers.

US2005/037944 to Grandmaire et al. discloses a medium viscosity, clear fabric softening composition comprising form about 1 to 20 wt % of an oligomeric esterquat, at least about 0.2% wt dipropylene glycol, an effective amount of a water insoluble perfume, and an effective amount of a thickening agent to provide a viscosity of from 80 to 700 m-Pas.

WO2002/072745 to The Procter & Gamble Company discloses a rinse added composition for the conditioning of fabric in a rinse, the composition comprising a fabric softener active, a suds suppressing system, and a surfactant scavenger.

WO2001/30951 to Reckitt Benckiser France discloses a washing and conditioning method using, in the main wash, one or more cleansing surfactants and one or more organic quaternary ammonium polymers.

EP1149891 to Goldschmidt Chemical Company discloses a low cost fabric softener for rinse cycle comprising a blend of a triglyceride-based ester quat and quaternary ammonium anionic scavenger.

WO 96/21715 to The Procter & Gamble Company discloses concentrated liquid fabric softener compositions stabilized by means of water-soluble polyesters.

U.S. Pat. No. 4,476,030 to Hoescht Aktiengesellschaft discloses concentrated masterbatches of fabric softeners.

U.S. Pat. No. 3,349,033 to Zuccarelli discloses stable laundry softeners having microbiologically active properties.

There remains a need for laundry compositions that provide germ kill and other benefits during a laundry rinse cycle, while being safer for the environment.

### SUMMARY OF INVENTION

Liquid laundry products comprising containers comprising liquid laundry compositions are disclosed. The liquid laundry compositions comprise approximately 2% wt to approximately 8% wt of a benzyl-substituted quaternary ammonium compound and score 75 or less under Test 437 from Organisation for Economic Cooperation and Development (OECD) titled Bovine Corneal Opacity and Permeability Test Method for Identifying Ocular Corrosives and Severe Irritants. As a result, the disclosed liquid laundry products do not require child-resistant packaging under 40 C.F.R. § 157, subpart B.

### Terms and Definitions

As used herein:
the symbol “˜” and the terms “approximately” and “about” mean plus or minus 10% of the value stated;
the term “a” or “an” means one or more;
any and all ranges are inclusive of their endpoints, e.g. a ranging from 1 wt % to 10 wt % includes 1 wt % and 10 wt % and any concentration between 1 wt % and 10 wt %;
all amounts given in % are % by weight (wt %) unless otherwise stated. When an ingredient does not contain close or equal to 100% active material, two percentages may be provided: one for the weight of the ingredient and one for the weight of the active. For example, 7.28% wt of benzalkonium chloride contains approximately 80% benzalkonium chloride in water, alcohol and/or polypropylene glycol, which equates to approximately 5.82% wt of benzalkonium chloride in the formulation. This would be represented as 7.28% wt (5.82% wt) of benzalkonium chloride;
the term “benzyl group” is C₆H₅CH₂—;
the term “comprising” is inclusive or open-ended and does not exclude any additional elements; the term “consisting of” excludes any additional elements; and the term “consisting essentially of” is in-between, only permitting additional elements that do not materially affect characteristics of the product or process;
the phrase “substantially free” means a concentration of less than 0.3 g/L, preferably less than 0.2 g/L, more preferably less than 0.1 g/L, and most preferably less than 0.05 g/L;
the abbreviation “q.s.” is short for the Latin term quantum satis which means the amount of which is enough and, as used herein, means the amount of water needed to bring the formulation to 100% wt.;
the terms “germ” and “microbe” or “microbial” means microorganisms which cause disease or undesirable effects, such as malodor, and encompasses both bacteria and viruses;
the terms “sanitize” or “sanitization” mean providing equal to or greater than a 3 log₁₀ reduction of microbes in 25 minutes according to ASTM 2274, including but not limited to Staphylococcus aureus and Klebsiella pneumoniae;
the terms “disinfect” or “disinfection” mean no growth observed during the micro testing;
the terms “biocide” or “biocidal” mean any product that can kill germs, including bacteria and viruses; biocides are substances approved to kill microorganisms and typically registered with a governing body (i.e., the US Environmental Protection Agency (EPA) or the European Chemicals Agency (ECHA));
the term “liquid” means a state of matter that conforms to the shape of the container in which it is held at room temperature (18-23° C.) and which acquires a defined surface in the presence of gravity; the term “liquid” is readily distinguishable from the terms “solid” and “gas.” Liquids are not pastes, which behaves as a solid until a sufficiently large load or stress is applied, even though a paste is also known as a Bingham plastic fluid;
the term “alone” means that no other ingredients are present, in other words, the stated ingredient is the only ingredient;
the term “ambient temperature” means room temperature which may vary depending on the season from approximately 18° C. to approximately 28° C., but preferably from approximately 20° C. to approximately 25° C.;
the term “aroma chemical” means a chemical substance that provides a scent;
the term “top note” refers to aroma chemicals having a boiling point less than or equal to 250° C. when measured at 1 atm pressures, preferably less than 225° C., more preferably less than 200° C. Top notes may also be referred to as head notes or opening notes. Exemplary top note aroma chemicals may be described as citrus, delicate, fresh, fruity, green, or light;
the term “bottom note” refers to aroma chemicals having a boiling point greater than to 250° C. when measured at 1 atm pressures, preferably greater than 275° C., more preferably 300° C. Bottom notes may also be referred to as base notes. Exemplary bottom note aroma chemicals may be described balsamic, floral heavy, musk, spicy, sweet, or woody;
the term “pro-fragrance” refers to a perfume compound which is able to release one or more aroma chemicals when triggered by an external influence. Release of the aroma chemical prolongs the perfuming effect. The release may be triggered by exposure to light, air, oxygen, heat, moisture, an enzyme, or any combination thereof;
the term “viscosity” refers to the resistance of a fluid to change to its shape or flow, i.e. the thickness in the consistency of the fluid. The higher the measurement, the more external force (stress) is required to allow the fluid to flow and the thicker the consistency of the fluid will be;
the term “rheology” refers to flow and deformation behavior in materials, typically regarding non-Newtonian fluids. In measurements, known shear stress is applied to a material and the resulting deformation, or strain, is monitored.

With these definitions, rheology is a more comprehensive measurement of the fluid behavior whereas viscosity is typically only referencing the thickness or consistency of the liquid.

### DETAILED DESCRIPTION

Liquid laundry products comprising containers comprising liquid laundry compositions are disclosed. The liquid laundry compositions comprise approximately 2% wt to approximately 8% wt of a benzyl-substituted quaternary ammonium compound and score 75 or less under Test 437 from Organisation for Economic Cooperation and Development (OECD) titled Bovine Corneal Opacity and Permeability Test Method for Identifying Ocular Corrosives and Severe Irritants. As a result, the disclosed liquid laundry products do not require child-resistant packaging under 40 C.F.R. § 157, subpart B.

The liquid laundry compositions disclosed comprise approximately 2% wt to approximately 8% wt of a benzyl-substituted quaternary ammonium compound, approximately 0.3% wt to approximately 1.5% wt of an alkylamine oxide, and approximately 0.4% wt to approximately 1% wt of phenoxyethanol.

The disclosed compositions may be used in laundry formats, such as a laundry biocide, a laundry sanitizer, a laundry softener, a laundry conditioner, a laundry fabric protector, or combinations thereof. Preferably, the disclosed compositions may serve two or more functions. For example, the disclosed composition may be a fabric protector and biocide, or a fabric protector and sanitizer, or a softener and biocide, or a softener and sanitizer, or a conditioner and biocide, or a conditioner and sanitizer. Alternatively, the disclosed composition may be a fabric protector and softener and conditioner. Alternatively, the disclosed composition may be a biocide and sanitizer.

For many consumers, the term “softener” has developed a negative connotation. Many softeners leave fabrics, and even the washing machine, feeling greasy. Athletic-wear or towels treated with softeners sometimes build up a residue that makes the fibers more hydrophobic, which may impair the moisture wicking capability of the fabric. As shown in the examples that follow, testing of the disclosed formulations on cotton and polyester indicate that the ability for the fabric to absorb moisture is not negatively impacted by the disclosed compositions. One of ordinary skill in the art will recognize that most athletic-wear contains polyester, spandex, and/or lycra and most towels contain cotton.

The disclosed compositions reduce and/or remove germs during the last rinse cycle of a laundry machine washing process. The disclosed compositions also reduce and/or remove malodor containing bacteria during the last rinse cycle of a laundry machine washing process. The disclosed compositions remain stable over time.

Industry leaders have predominantly utilized quaternary ammonium compounds (quats) in order to provide consumers with a germ kill benefit. Quats are typically cheap, readily available, and offer a satisfactory level of disinfection to the consumer. Despite these benefits, quats are known to be toxic to aquatic environments with potential long-lasting effects. Even though quats are expected to biodegrade, regulatory bodies (e.g., the US Environmental Protection Agency) may prohibit individuals from making biodegradability claims if these compounds are present in any amount.

The disclosed compositions comprise a low concentration of quats, but are still able to obtain germ kill when diluted during the last rinse cycle of an automatic clothes washing process. The disclosed compositions comprise approximately 2% wt to approximately 8% wt of a benzyl-substituted quaternary ammonium compound, preferably between approximately 3% wt and approximately 7% wt, and more preferably between approximately 2% wt and approximately 4% wt. Benzyl-substituted quaternary ammonium compounds have the formula: C₆H₅CH₂NR₃⁺X⁻, wherein each R is independently a C1-C18 hydrocarbon group and X is an alkali metal, saccharinate group, or carbonate group. R is not an ether or alkoxy group. A C1-3 alkyl group may also be linked to the benzyl ring (e.g., ethylbenzyl C12-18 dimethyl benzyl ammonium chloride).

Preferably the benzyl-substituted quaternary ammonium compound has the formula C₆H₅CH₂N(CH₃)₂R⁺X⁻, wherein R is a C12-C18 or C12-C16 alkyl group and X is Cl.

The disclosed compositions comprise an alkylamine oxide non-ionic surfactant. The alkylamine oxide may be a C10-C14 alkylamine oxide, preferably lauramine oxide, decylamine oxide, or dimethyltetradecylamine oxide; more preferably lauramine oxide or decylamine oxide. The composition may comprise approximately 0.3% wt to approximately 1.5% wt alkylamine oxide, preferably between approximately 0.4% wt to approximately 1% wt, more preferably between approximately 0.5% wt to approximately 1% wt, and most preferably between approximately 0.6% wt to approximately 1% wt. The composition may comprise approximately 0.3% wt to approximately 1.5% wt C10-C14 alkylamine oxide, preferably between approximately 0.4% wt to approximately 1% wt, more preferably 0.5% wt to approximately 1% wt, and most preferably 0.6% wt to approximately 1% wt. The composition may comprise approximately 0.3% wt to approximately 1.5% wt lauramine oxide, preferably between approximately 0.4% wt to approximately 1% wt, more preferably between approximately 0.5% wt to approximately 1% wt, and most preferably between approximately 0.6% wt to approximately 1% wt. The composition may comprise approximately 0.3% wt to approximately 1.5% wt decylamine oxide, preferably between approximately 0.4% wt to approximately 1% wt, more preferably between approximately 0.5% wt to approximately 1% wt, and most preferably between approximately 0.6% wt to approximately 1% wt. As shown in the examples that follow, the alkylamine oxide enhances the antimicrobial efficacy of the benzyl-substituted quaternary ammonium compound. However, alkylamine oxides may also produce foaming, which is not desired in the final rinse cycle. As a result, concentrations should remain below 1% wt.

The disclosed compositions comprise phenoxyethanol. The composition may comprise approximately 0.4% wt to approximately 1% wt phenoxyethanol, preferably between approximately 0.5% wt to approximately 0.9% wt, and more preferably between approximately 0.8% wt to approximately 0.9% wt. As shown in the examples that follow, the phenoxyethanol enhances the antimicrobial efficacy of the benzyl-substituted quaternary ammonium compound.

The disclosed compositions further comprise between approximately 0.5% wt to approximately 1% wt citric acid, preferably between approximately 0.6% wt to approximately 0.9% citric acid. Citric acid serves as both an acidifier and chelant. As a result, the disclosed compositions may be substantially free of any additional chelant besides the citric acid, such as EDTA, GLDA, etc. Citric acid may also further enhance the antimicrobial efficacy of the benzyl-substituted quaternary ammonium compound.

The disclosed compositions also include water, preferably soft water. Soft water comprises less than 17 ppm of calcium and magnesium, preferably less than 5 ppm of each. The disclosed compositions comprise between approximately 80% wt to approximately 97.5% wt water. As a result, the disclosed compositions are liquid. The pH of the disclosed compositions measured neat at 20° C. ranges from approximately 2 to approximately 4, preferably from approximately 2.5 to approximately 3.15. This pH range provides improved antimicrobial efficacy to the benzyl-substituted quaternary ammonium compounds. This pH range may also contribute to improved limescale removal as compared to compositions at higher pH ranges. Limescale traps dirt, odors, and germs. As a result, the removal of limescale from fabrics at pH 2-4 provides heightened freshness of the fabrics.

The compositions disclosed above comprise all the ingredients necessary for germ kill and may serve as a biocide and sanitizer. These compositions are single-phase liquids at room temperature, preferably clear single-phase liquids.

The disclosed compositions do not include any additional known germ kill actives in order to achieve germ kill. The benzyl-substituted quaternary ammonium compound is the only quat used in the disclosed compositions. In other words, the disclosed compositions do not include any additional quaternary ammonium compounds, such as dialkyl dimethyl ammonium chloride. Multiple quaternary ammonium species may help achieve sanitization and/or provide better breadth of germ kill. As a result, most commercial sanitizers include a blend of two or more quaternary ammonium compounds. As shown in the examples that follow, Applicant has surprisingly discovered that a composition comprising only the benzyl-substituted quaternary ammonium compound may achieve better than or equivalent germ kill to a composition comprising a multi-quat system. Dialkyl dimethyl ammonium chlorides are currently more expensive than benzyl-substituted quaternary ammonium compounds. As a result, the disclosed compositions provide equivalent or better germ kill in a more cost effective manner.

Applicant also believes that using the benzyl-substituted quaternary ammonium compound as the only quat in acidic formulations provides an improved safety profile as compared to products containing two or more quaternary ammonium compounds in solutions. In vitro assays in accordance with the Organisation for Economic Cooperation and Development (OECD) Method 437 were performed on multiple different compositions with various levels of quaternary ammonium compounds (see Example 11). Applicant was surprised to find that no eye corrosivity was observed when testing variations of the disclosed compositions. Based on these results, packaging for the disclosed compositions will not require a child resistant closure. Currently, US in-market sanitizers require child resistant closures due to eye and/or skin corrosivity.

The disclosed compositions do not include any additional known germ kill actives in order to achieve germ kill. As a result, the disclosed compositions are also substantially free of peroxides, such as hydrogen peroxide or peracids. The disclosed compositions are also substantially free of guanides, such as bisguanide. The disclosed compositions are substantially free of alkali metal hypochlorites which benefits the consumers as hypochlorites can deliver germ kill; however, are well known to damage many types of colored fabrics. The disclosed compositions are substantially free of isocyanurates. The disclosed compositions are also substantially free of borates, such as boric acid or perborates.

The disclosed compositions may also be substantially free of any polyquaternium polymers. As shown in the examples that follow, suitable germ kill is obtained from compositions comprising the benzyl-substituted quaternary ammonium compound alone. However, as will be discussed in more detail infra, addition of some polyquaterniums may also improve germ kill.

Particularly good results were achieved using approximately 5% wt to approximately 6% wt benzyl-substituted quaternary ammonium compound, approximately 0.4% wt to approximately 0.5% wt alkyl amine oxide, approximately 0.4% wt to 0.6% wt phenoxyethanol, approximately 0.5% wt to approximately 1% wt citric acid, and approximately 0.01% wt to approximately 0.03% wt sodium hydroxide. Addition of approximately 0.3% wt to approximately 0.8% wt of PQ6 or PQ37 provided improved germ kill with lower concentrations of benzyl-substituted quaternary ammonium compound. Addition of approximately 0.5% wt to approximately 1.5% wt EGHE also provided improved germ kill with lower concentrations of benzyl-substituted quaternary ammonium compound. One particularly preferred embodiment comprises approximately 3% wt to approximately 3.5% wt benzyl-substituted quaternary ammonium compound, approximately 0.6% wt to approximately 1% wt alkyl amine oxide, approximately 0.8% wt to 0.9% wt phenoxyethanol, approximately 0.5% wt to approximately 1% wt citric acid, approximately 0.01% wt to approximately 0.03% wt sodium hydroxide, approximately 0.3% wt to approximately 0.8% wt of PQ6 or PQ37, and approximately 0.5% wt to approximately 1.5% wt EGHE.

To improve functionality of the disclosed compositions, a fabric softener, conditioner, and/or protector may be added. The disclosed compositions may comprise approximately 2% wt to approximately 5% wt, preferably from approximately 3% wt to approximately 4% wt, of this material.

The fabric softener, conditioner, and/or protector may be stearyldimonium hydropropyl hydrolyzed wheat protein. One exemplary commercial stearyldimonium hydropropyl hydrolyzed wheat protein suitable for use in the teachings herein is the stearyldimonium hydropropyl hydrolyzed wheat protein sold by Croda under the tradename Coltide™ HQS.

Alternatively, the fabric softener, conditioner, and/or protector may be a copolymer of hydrolyzed wheat protein and silicone. Two exemplary commercial copolymers suitable for use in the teachings herein are the hydrolysed wheat protein and silicone sold by Croda under the tradename Coltide™ HSi or Coltide™ Radiance. Coltide™ Radiance also provides color protection to, and reduces pilling of, the fabric being treated. Coltide™ Radiance also lubricates the fibers and provides shape protection to the fabric, helping clothing retain its original shape after washing. Coltide™ Radiance is typically used in a detergent during the wash cycle of the automatic laundry process. Applicant believes improved benefits will be obtained by moving use of this material to the rinse cycle.

In another alternative, the fabric softener, conditioner, and/or protector may be a liquid ethoxyquat, particularly a non-polymeric alkoxy quaternary ammonium salt. The liquid non-polymeric alkoxy quaternary ammonium salt may be N,N′-di(alkylcarboxyethyl)-N-hydroxyethyl-N-methylammonium sulfate. One exemplary commercial source of N,N′-di(alkylcarboxyethyl)-N-hydroxyethyl-N-methylammonium sulfate is Rewoquat™ WE 45 (75% in ethanol) from Evonik. This water soluble ethoxyquat permits formulation of single-phase liquids at room temperature, preferably clear single-phase liquids. Applicant believes that this softener may chemically bind with the fabric, rather than forming a coating on the fabric. This mechanism leaves clothes feeling soft without having a greasy residue, even after multiple washes. This mechanism may also permit the use of a lower concentration of fabric softener than is traditionally used, while maintaining or even exceeding softness feel.

In another alternative, the disclosed compositions are substantially free of any ethoxyquats.

To improve aesthetics of the disclosed compositions, a polysaccharide, particularly a cellulose based material, may be added. The polysaccharide or cellulose based material may serve as a thickener. The polysaccharide or cellulose based material may serve as a suspending agent. The polysaccharide or cellulose based material may serve as a softener. The polysaccharide or cellulose based material may be carboxymethyl cellulose, hydroxyethylcellulose, hydropropylmethylcellulose, methylhydroxyethylcellulose, xanthan gum, a fermentation derived cellulose, or combinations thereof. The disclosed compositions comprise between approximately 0.1% wt and approximately 0.5% wt cellulose based material, preferably between approximately 0.25% wt and approximately 0.45% wt.

Addition of the cellulose based material may transform the disclosed compositions from single phase liquids to colloidal systems. After addition of the cellulose based material, the disclosed compositions have an initial viscosity of approximately 200 cPs as measured after 60 seconds at 50 RPM using a LV62 spindle at ambient temperature. By adding different types of cellulose, both viscosity at rest as well as viscosity in motion may be improved (e.g., fermented cellulose materials may help improve viscosity at rest while polysaccharide or cellulose thickeners may help improve viscosity in motion).

The viscosity of traditional fabric softeners typically increases with time. Thickening may also occur on exposure to high temperatures or freeze/thaw conditions. Thickened fabric softeners may become unusable for the consumer without the added step of diluting (and reducing effectiveness).

As shown in the stability testing examples that follow, Applicant expects the viscosity of the disclosed compositions to remain close to the initial viscosity or decrease slightly over time. Applicant expects the viscosity of the disclosed composition to remain within approximately 50% to 90% of the initial viscosity over approximately 2 years time, preferably within approximately 65% to 85% of the initial viscosity. As a result, the disclosed compositions may be used in hot climates or subject to freeze/thaw conditions or even just kept on the shelf for longer than traditional fabric softeners without encountering the thickness issues.

The cellulose based material may be hydroxyethylcellulose. One exemplary commercial hydroxyethylcellulose suitable for use in the teachings herein is hydroxyethylcellulose sold by Dow under the tradename Cellosize™ QP100. A 1% wt solution of the cellulose based material has a viscosity ranging from approximately 4,400 cPs to approximately 6,000 cPs as measured using a Brookfield viscometer at 25° C. The cellulose based material has a bulk density ranging from approximately 0.3 g/cm³ to approximately 0.6 g/cm³. The hydroxyethylcellulose functions mainly as a thickener. Another exemplary commercial hydroxyethylcellulose suitable for use in the teachings herein is hydroxyethylcellulose sold by Ashland under the tradename Natrosol™ 250 HHR. This hydroxyethylcellulose is water soluble. As a result, the disclosed compositions remain single phase solutions. As shown in the examples that follow, single phase solutions typically exhibit better stability than emulsions. Many commercially available fabric softeners are emulsions. This hydroxyethylcellulose is also nonionic and unaffected by cations. As a result, this hydroxyethylcellulose does not negatively impact the biocidal efficacy of the benzyl-containing quaternary ammonium compound. This hydroxyethylcellulose functions mainly as a thickener, giving the disclosed composition viscosity.

The cellulose based material may be methylhydroxyethylcellulose. One exemplary commercial methylhydroxyethylcellulose suitable for use in the teachings herein is the methylhydroxyethylcellulose sold by Dow under the tradename SupraCare™ 780. A 1% wt solution of the cellulose based material has a viscosity ranging from approximately 12,000 cPs to approximately 16,000 cPs as measured using a Haake Roto Visco RV 100 with a shear rate of 2.55 S⁻¹ at 20° C. A 1% wt solution of the cellulose based material has a pH ranging from approximately 6 to approximately 7 at 20° C. The methylhydroxyethylcellulose functions mainly as a thickener.

The cellulose based material may be a fermentation derived cellulose. Fermentation derived cellulose is beneficial because the material does not contain microplastic found in other thickeners, such as styrene-containing and/or polyacrylate polymers. Microplastics contain repeating units that do not break down over time. As a result, microplastics may be bad for the environment, ending up in the food chain and causing further problems, such as endocrine or reproductive system disruptions. In the Fast Moving Consumer Goods space, there is a growing trend to avoid formulations containing microplastics to alleviate these potential concerns. The disclosed compositions may be substantially free of microplastic materials. One exemplary commercial fermentation derived cellulose suitable for use in the teachings herein is a fermentation derived cellulose sold by CP Kelco under the tradename Cellulon™ RC-76. Another exemplary commercial fermentation derived cellulose suitable for use in the teachings herein is the fermentation derived cellulose sold by CP Kelco under the tradenames Cellulon™ R88 or Cellulon™ R93. The fermentation derived celluloses are particularly useful for suspending materials, such as encapsulated fragrances or opacifiers that are frequently included in laundry formulations. The fermentation derived celluloses may be used as both the thickening and suspending agent. Alternatively, the disclosed compositions may comprise approximately 0.75% wt to approximately 3% wt of the fermentation derived cellulose acting as a suspending agent combined with approximately 0.1% wt to approximately 0.5% wt of a hydroxyethylcellulose thickening agent.

The cellulose based material may be a blend of hydropropylmethylcellulose, xanthan gum, and cetyl-hydroxy ethyl cellulose. This blend is commercially available from Ashland under the tradename Ecothix™. This blend also provides a softening benefit to fabrics. This blend may be used alone as both a thickening and softness agent. Alternatively, a low concentration of this blend may be used as a softener with another cellulose serving as the thickener. For example, the disclosed compositions may comprise approximately 0.05% wt to approximately 0.25% wt of this blend with approximately 0.45% wt to approximately 0.75% wt of a methylhydroxyethylcellulose thickening agent.

In addition to water, the disclosed composition may comprise a carrier solvent. Exemplary carrier solvents include methanediol, 1,2-propanediol, 1,3-propanediol, 1,2-butanediol, 1,3-butanediol, 1,4-butanediol, 2,3-butanediol, polyethyelene glycol, polypropylene glycol, propylene glycol phenyl ether, ethylene glycol monohexyl ether, glycerin, water, or combinations thereof. Preferably carrier solvents include 1,2-propanediol, 1,3-propanediol, glycerin, ethylene glycol mono hexyl ether (EGHE), propylene glycol phenyl ether, water, and combinations thereof. 1,2-propanediol and EGHE are particularly preferred. The disclosed compositions comprise between approximately 0.1% wt to approximately 2.5% wt of non-aqueous carrier solvent, preferably between approximately 0.25% wt to approximately 2% wt of a non-aqueous carrier solvent. One of ordinary skill in the art will recognize that many raw materials are supplied in non-aqueous carrier solvents. As a result, the disclosed composition may comprise between approximately 0.25% wt to approximately 1% wt of added non-aqueous carrier solvent, such as propylene glycol (i.e., 1,2-propanediol), preferably between approximately 0.3% wt to approximately 0.75% wt. The non-aqueous solvent may enhance stability of the disclosed compositions at low temperatures. As shown in the examples that follow, certain solvents, such as propylene glycol phenyl ether or EGHE, have been shown to improve micro efficacy of the benzyl-substituted quaternary ammonium compounds. Applicants further believe that EGHE may improve the wettability of the fabric. EGHE may also improve penetration of the benzyl-substituted quaternary ammonium compound into the fabric fibers, where germs may be hiding.

Alternatively, the disclosed compositions may be substantially free of non-aqueous solvents, such as glycol ethers. The disclosed compositions may also be substantially free of added alcohols, such as ethanol. One of ordinary skill in the art will recognize that the benzyl-substituted quaternary ammonium compounds are frequently supplied in an alcohol or glycol solvent. However, more of these solvents are not deliberately added to the disclosed compositions.

The disclosed compositions further comprise fragrance. The disclosed compositions comprise approximately 0.1% wt to approximately 1.5% wt, preferably approximately 0.5% wt to approximately 1.25% wt, more preferably approximately 0.7% wt to approximately 1% wt. One of ordinary skill in the art will recognize that the aroma chemicals in most fragrances are stable at neutral pHs and less stable at the acidic and basic pH extremes. As a result, there are fewer aroma chemicals that remain stable at the acidic pH of the disclosed compositions, producing additional complications.

The fragrance may comprise malodor control technology, such as receptor blocking and/or chemical binding technologies. Receptor blocking technology blocks the smell of malodor by test subjects, i.e., humans. Chemical binders may chemically bind a better smelling chemical to the malodor chemical. Alternatively, the chemical binder may make the malodor chemical heavy to prevent its volatilization and detection by test subjects. Exemplary malodor control chemicals include but are not limited to soyaethyl morpholinium ethosulfate; dipropylene glycol; alkanolamine; 7-methyloctyl acetate; 3a,4,5,6,7,7a-hexahydro-4,7-methano-1H-indenyl acetate; 1-(5,5-dimethyl-1-cyclohexen-1-yl)-4-penten-1-one; 2,2,7,7-tetramethyltricyclo[6.2.1.0(1,6)]undec-4-en-3-one; 3-methyl-5-phenylpentan-1-ol; and any combinations thereof. One of ordinary skill in the art will recognize that measuring malodour intensity reduction differs from measuring fragrance longevity over time. Malodour intensity reduction may also be tested against a variety of malodours, such as body, pet, mold, mildew, etc.

Consumers prefer clothes that smell good. As a result, the scent of the fragrance used in the disclosed compositions is selected to be detectable by a subject on the treated material for up to two weeks, preferably up to four weeks, and more preferably up to eight weeks.

Applicant believes that a fragrance comprising more bottom notes than top notes will help provide long-lasting scent.

While not exhaustive due to the large number of top notes available, exemplary top notes include, but are not limited to, adoxal, allyl cyclohexane propionate, alpha pinene, alpha terpineol, alpha thujone, benzaldehyde, benzyl alcohol, beta gamma hexenol, beta pinene, borneol, bornyl acetate, camphor, carvacrol, carvone, cis-3-hexenol, cis-3-hexenyl acetate, citral, citronellal nitrate, citronellol, citronellyl acetate, decyl alcohol, dimethyl acetal, dimethyl benzyl carbinol, 2,6-dimethyl-5-hepten-1-al, eucalyptol, geraniol, geranyl acetate, geranyl nitrile, hexyl acetate, hydroquinone dimethyl ether, hydroxycitronellal, iso-amyl acetate, iso-amyl alcohol, limonene, linalool, linalyl acetate, menthol, menthone, methyl heptenone, octanol, phenyl acetaldehyde, phenyl ether alcohol, phenyl ethyl dimethyl carbinol, phenyl propyl alcohol, prenyl acetate, rose oxide cis or trans, thymol, tetrahydrolinalool, triplal, verdox, or any combinations thereof.

While not exhaustive due to the large number of bottom notes available, exemplary bottom notes include, but are not limited to, aldrone, ambroxan, benzophenone, benzyl benzoate, benzyl cinnamate, benzyl phenyl acetate, cepionate, cetalox, citronellyl ethoxalate, cresyl caprylate para, cresyl phenyl acetate para, cyclohexal, diethyl phthalate, dione, dodecalaclactone delta, dodecalactone gamma, ethyl maltol, ethyl vanillin, eugenyl phenyl acetate, evernyl, fixolide, geranyl phenyl acetate, geranyl tiglate, hedione, hexyl cinnamic aldehyde, hexyl salicylate, hyacinth acetals, laitone, linalyl benzoate, linalyl cinnamate, linalyl phenyl acetate, methyl cedryl ketone, rosacetol timberol, undecalactone, vanillin, or any combinations thereof.

One of ordinary skill in the art will recognize that each of these aroma chemicals has a different boiling point at 1 atm pressure, notwithstanding the “top note” or “bottom note” designation. As a result, each aroma chemical will exhibit a different evaporation profile. A fragrance containing more bottom notes than top notes will evaporate more slowly and remain on the material longer. To provide an improved sensory experience from the disclosed compositions, the fragrance requires more bottom notes than top notes.

The fragrance may comprise a pro-fragrance. Applicant has defined a pro-fragrance as a perfume compound which is able to release one or more aroma chemicals when triggered by an external influence. Release of the aroma chemical prolongs the perfuming effect. The release may be triggered by exposure to light, air, oxygen, heat, moisture, an enzyme, or any combination thereof. As a result, the scent of the profragrance may be detectable by a subject on the treated material for up to two weeks, preferably up to four weeks, and more preferably up to eight weeks. Exemplary pro-fragrance perfume compounds include but are not limited to 3-(dodecylthio)-1-(2,6,6-trimethylcyclohex-3-en-1-yl)butan-1-one sold by Firmenich under the trade name HaloScent™ D, 4-(dodecylthio)-4-(2,6,6-trimethylcyclohex-2-en-1-yl)butan-2-one sold by Firmenich under the trade name HaloScent™ I, 4-(dodecylthio)-4-(2,6,6-trimethylcyclohex-1-en-1-yl)butan-2-one sold by Firmenich under the trade name HaloScent™ I, ethyl N,S-bis (4-oxo-4-(2,6,6-trimethylcyclohex-3-en-1-yl)butan-2-yl)cysteinate sold by Givaudan under the tradename Scentaurus™ Berry, ethyl (Z)-2-acetyl-4-methyltridec-2-enoate sold by Givaudan under the tradename Scentaurus™ Clean, 4-(dodecylthio)-4-methylpentan-2-one sold by Givaudan under the tradename Scentaurus™ Juicy, or any combination thereof.

The fragrance may comprise additional materials standard in the fragrance industry including but not limited to solvents, viscosity agents, stabilizing agents, coloring agents, preservatives, fixatives, insect repellants, or any combination thereof.

The disclosed compositions may further comprise an encapsulated fragrance. The encapsulated fragrances are suspended in the disclosed compositions. Encapsulated fragrances provide long term fragrance benefits to fabrics. The encapsulated fragrance is captured in the fabric during the rinse process and releases the fragrance when the encapsulate degrades with time or bursts from pressure. Many classical encapsulated fragrances utilized shells that release formaldehyde. Exposure to formaldehyde may cause adverse health effects. Therefore, the disclosed compositions are substantially free of any encapsulated fragrances that release formaldehyde. Preferably, the fragrance is encapsulated by a polyacrylate or biodegradable shell.

Applicant believes that the disclosed compositions provide improved deposition of encapsulated fragrances having polyacrylate shells or any other shells having a negative charge. Applicant theorizes that the positively charged benzyl-substituted quaternary and/or benzyl-substituted polyquaternium compound binds to both the negative charge of the polyacrylate shell and to fiber sites on the clothing, leading to improved fragrance deposition. The combination of encapsulated fragrance with the long lasting or profragrance technology is theorized to lead to better long-term performance (see Example 12 below) by providing technologies that evaporate slowly over time and/or provide quick bursts of freshness in the presence of friction, leading to a longer perceived fragrance experience.

Exemplary encapsulated fragrances suitable for use in the disclosed compositions may be formed from the reaction product of at least one multifunctional alpha, beta-unsaturated carbonyl compound with a nanocellulose or microcrystalline cellulose. The alpha, beta-unsaturated carbonyl compound may be a multifunctional methacrylate, such as glycerol dimethacrylate, ethylene glycol dimethacrylate, butylene glycol dimethacrylate, propylene glycol dimethacrylate, bisphenol A dimethacrylate, and mixtures thereof. More details may be found in PCT Published Patent App No WO2022/249052 to Takasago Int'l Corp, the details of which are incorporated in its entirety herein by reference.

Alternatively, exemplary encapsulated fragrances suitable for use in the disclosed compositions may be formed by reacting a polyfunctional monomer with a reactant in the presence of a plant-based protein. For example, acyl chloride may be reacted with one or more amino compounds in the presence of a potato protein or chickpea protein. Exemplary amino compounds include ethylene diamine, diethylene triamine, L-lysine, or combinations thereof. More details may be found in PCT Published Patent App No WO2023/057262 to Firmenich SA, the details of which are incorporated in its entirety herein by reference.

One of ordinary skill in the art will recognize that dispersion of both the benzyl-substituted quaternary ammonium compound and the encapsulated fragrance in an acidic aqueous carrier provides potential stability issues. More specifically, the formulation may separate. The disclosed compositions solve these stability issues.

When the disclosed compositions comprise encapsulated fragrances, the resulting composition may be opaque. As a result, the disclosed compositions may be substantially free of any opacifiers. Alternatively, the disclosed compositions may further comprise an opacifier. Opacifiers are added purely for aesthetic reasons to give the appearance of “traditional” fabric conditioners. The disclosed compositions may comprise between approximately 0.1% wt to approximately 0.5% wt opacifier. An exemplary opacifier may be a blend of cocamidopropyl betaine and glycol distearate. This exemplary opacifier is commercially available from Solvay under the tradename Miracare™ OPR2, previously known as Mackadet™ OPR2. Alternatively, the opacifier may be a blend of ethylene distearate and hydroxyethyl stearate sold under the tradename Dapracare™ OPC-1 by Italmatch Chemicals S.p.A. In another alternative, the opacifier may be a blend of ethylene distearate and a nonionic surfactant sold under the tradename Dapracare™ OPC-3 by Italmatch Chemicals S.p.A. In yet another alternative, the opacifier may be PEG-2 stearate sold under the tradename Cithrol™ DEGMS by Croda.

Alternatively, the disclosed compositions may be substantially free of any additional non-ionic surfactants besides the alkylamine oxide. Specifically, the disclosed compositions may be substantially free of betaine surfactants. The disclosed compositions may also be substantially free of unsaturated fatty alcohols.

The disclosed compositions are substantially free of anionic surfactants, such as alkyl sulfates and alkyl ether sulfates. Anionic surfactants tend to introduce foaming, which is not desired in the final rinse stage of a laundry process. Additionally, anionic surfactants can also reduce the efficacy of cationic biocidal and softener molecules, which is not desirable for commercial laundry sanitizers or fabric conditioners.

The disclosed compositions may further comprise enzymes for additional benefits. Cellulase keeps clothes looking new longer. Phosphodiesterase helps remove body stains from clothes. Amylase and protease help remove generic stains from clothes, including enzymatic stains left behind by detergents. Amylase and/or protease also help remove food for bacteria, which may lead to bad smells.

Alternatively, the disclosed compositions may be substantially free of enzymes, particularly when other benefits are not needed or when the enzymes are not compatible with the acidic formulations.

The disclosed compositions may be substantially free of alkanolamine, such as monoethanolamine, diethanolamine, triethanolamine, or combinations thereof.

The disclosed compositions may be substantially free of an added electrolyte, such as sodium chloride. Electrolytes may destabilize the disclosed compositions.

Exemplary laundry compositions comprise approximately 2% wt to approximately 8% wt of a benzyl-substituted quaternary ammonium compound, approximately 0.3% wt to approximately 1.5% wt of an alkylamine oxide, and approximately 0.4% wt to approximately 1% wt of phenoxyethanol.

Exemplary laundry compositions comprise:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Water | q.s. | q.s. |

Applicants believe that when used during the last rinse cycle of a laundry washing process, these laundry compositions obtain a 5 log₁₀ reduction using EN1276 in Staphylococcus aureus, Enterococcus hirae, Escherichia coli, and Pseudomonas aeruginosa and a 4 log₁₀ reduction using EN1650 in Candida albicans. This means the above formulation qualifies as a laundry disinfectant composition under European regulations.

The laundry compositions may further comprise a fabric conditioner, which provides a softness effect to the fabric, for example to cotton fibers. The exemplary laundry compositions may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Esterquat | ~2 to ~5 | ~3 to ~4 |
| Water | q.s. | q.s. |

The laundry compositions may further comprise an enzyme, which may impart additional benefits to clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Enzyme | ~0.1 to ~4 | ~0.25 to ~1.5 |
| Water | q.s. | q.s. |

The laundry compositions may further comprise a cellulase enzyme, which may help keep clothes treated with the disclosed compositions looking new for longer. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulase (e.g., Celluclean ™ | ~0.1 to ~1 | ~0.1 to ~0.75 |
| or Carezyme Essential from | | |
| Novozymes) | | |
| Water | q.s. | q.s. |

The laundry compositions may further comprise a phosphodiesterase enzyme, which help remove body stains from clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Phospodiesterase (e.g., Pristine ™ | ~0.1 to ~4 | ~0.5 to ~2 |
| 100L from Novozymes) | | |
| Water | q.s. | q.s. |

The laundry compositions may further comprise an amylase and/or protease enzyme, which may help remove generic stains from clothes treated with the disclosed compositions, including enzymatic stains left behind by detergents. These enzymes help remove food for bacteria, which may cause bad smells. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Protease (e.g., Progress | ~0.1 to ~4 | ~0.25 to ~0.75 |
| Uno from Novozymes) | | |
| Water | q.s. | q.s. |

For aesthetic reasons, the laundry compositions may further comprise thickeners. The thickeners produce a composition having a viscosity ranging from 100 cPs to 500 cPs as measured using a Brookfield viscometer with LV62 spindle at 50 RPM at ambient temperature. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulose based thickener | ~0.1 to ~0.5 | ~0.25 to ~0.45 |
| Dye | 0 to ~0.002 | ~0.0008 to ~ 0.0018 |
| Fragrance | 0 to ~2 | ~0.3 to ~1.5 |
| Water | q.s. | q.s. |

Compositions that meet germ kill and other aesthetic parameters may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulose based thickener | ~0.1 to ~0.5 | ~0.25 to ~0.45 |
| Enzyme | ~0.1 to ~4 | ~0.25 to ~1.5 |
| Dye | 0 to ~0.002 | ~0.0008 to ~ 0.0018 |
| Fragrance | 0 to ~2 | ~0.3 to ~1.5 |
| Water | q.s. | q.s. |

Compositions that meet germ kill and help keep clothes looking new for longer may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulose based thickener | ~0.1 to ~0.5 | ~0.25 to ~0.45 |
| Cellulase (e.g., Celluclean ™ | ~0.1 to ~1 | ~0.1 to ~0.75 |
| or Carezyme Essential from | | |
| Novozymes) | | |
| Dye | 0 to ~0.002 | ~0.0008 to ~ 0.0018 |
| Fragrance | 0 to ~2 | ~0.3 to ~1.5 |
| Water | q.s. | q.s. |

Compositions that meet germ kill and help remove body stains from clothes treated with the disclosed compositions may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulose based thickener | ~0.1 to ~0.5 | ~0.25 to ~0.45 |
| Phospodiesterase (e.g., Pristine ™ | ~0.1 to ~4 | ~0.5 to ~2 |
| 100L from Novozymes) | | |
| Dye | 0 to ~0.002 | ~0.0008 to ~ 0.0018 |
| Fragrance | 0 to ~2 | ~0.3 to ~1.5 |
| Water | q.s. | q.s. |

Compositions that meet germ kill and help remove generic stains from clothes treated with the disclosed compositions, including enzymatic stains left behind by detergents, may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulose based thickener | ~0.1 to ~0.5 | ~0.25 to ~0.45 |
| Protease (e.g., Progress | ~0.1 to ~4 | ~0.25 to ~0.75 |
| Uno from Novozymes) | | |
| Dye | 0 to ~0.002 | ~0.0008 to ~ 0.0018 |
| Fragrance | 0 to ~2 | ~0.3 to ~1.5 |
| Water | q.s. | q.s. |

Formulations that provide germ kill, viscosity, and softness may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Cellulose based thickener | ~0.1 to ~0.5 | ~0.25 to ~0.45 |
| Esterquat | ~2 to ~5 | ~3 to ~4 |
| Dye | 0 to ~0.002 | ~0.0008 to ~ 0.0018 |
| Fragrance | 0 to ~2 | ~0.3 to ~1.5 |
| Water | q.s. | q.s. |

These formulations remain clear, single phase solutions, particularly when the cellulose based thickener is 2-hydroxyethyl ether cellulose and the esterquat is a liquid N,N′-di(alkylcarboxyethyl)-N-hydroxyethyl-N-methylammonium methyl sulfate. This cellulose and esterquat have been carefully selected to be compatible with the benzyl-substituted quaternary ammonium compound. Neither contains any anionic component that may decrease the efficacy of the BKC. As shown in the examples that follow, the components of this formulation remain stable, with no significant change in physical/chemical properties over time.

For aesthetic reasons, the laundry compositions may further comprise a suspending agent, an opacifier, encapsulated fragrance, or any combination thereof. Encapsulated fragrances in the laundry formulations helps fabrics remain fresh long after washing. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Esterquat | ~2 to ~5 | ~3 to ~4 |
| Cellulose based thickener | ~0.1 to ~0.5 | ~0.25 to ~0.45 |
| Fermentation based suspending | ~1 to ~4 | ~1.5 to ~2.5 |
| agent (e.g., Cellulon ™ R93) | | |
| Opacifier and/or encapsulated | ~0.05 to ~2 | ~0.07 to ~1.5 |
| fragrance, preferably having a | | |
| polyacrylate or biodegradable shell | | |
| (i.e., not formaldehyde-releasing | | |
| shells) | | |
| Water | q.s. | q.s. |

In another example, the exemplary laundry compositions comprise, consist essentially

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Esterquat | ~2 to ~5 | ~3 to ~4 |
| Cellulose based thickener | ~0.1 to ~0.5 | ~0.25 to ~0.45 |
| Polyquaternium based suspending | ~1 to ~3 | ~1.5 to ~2.5 |
| agent (e.g., polyquaternium 37) | | |
| Opacifier and/or encapsulated | ~0.05 to ~2 | ~0.07 to ~1.5 |
| fragrance, preferably having a | | |
| polyacrylate or biodegradable shell | | |
| (i.e., not formaldehyde-releasing | | |
| shells) | | |
| Water | q.s. | q.s. |

Dye and additional fragrance may be added to improve the aesthetic appeal of the resulting formulation. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Propylene glycol | ~0.25 to ~1 | ~0.3 to ~0.75 |
| Citric acid | ~0.5 to ~1 | ~0.6 to ~0.9 |
| Sodium Hydroxide | ~0.01 to ~0.05 | ~0.02 to ~0.04 |
| Esterquat | ~2 to ~5 | ~3 to ~4 |
| Cellulose based thickener | ~0.1 to ~0.5 | ~0.25 to ~0.45 |
| Fermentation based suspending | ~1 to ~4 | ~1.5 to ~2.5 |
| agent (e.g., Cellulon ™ R93) | | |
| Opacifier and/or encapsulated | ~0.05 to ~2 | ~0.07 to ~1.5 |
| fragrance, preferably having a | | |
| polyacrylate or biodegradable | | |
| shell (i.e., not formaldehyde- | | |
| releasing shells) | | |
| Dye | 0 to ~0.002 | ~0.0008 to ~0.0018 |
| Fragrance | 0 to ~2 | ~0.3 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Propylene glycol | ~0.25 to ~1 | ~0.3 to ~0.75 |
| Citric acid | ~0.5 to ~1 | ~0.6 to ~0.9 |
| Sodium Hydroxide | ~0.01 to ~0.05 | ~0.02 to ~0.04 |
| Esterquat | ~2 to ~5 | ~3 to ~4 |
| Cellulose based thickener | ~0.1 to ~0.5 | ~0.25 to ~0.45 |
| Polyquaternium based | ~1 to ~3 | ~1.5 to ~2.5 |
| suspending agent (e.g., | | |
| polyquaternium 37) | | |
| Oacifier and/or encapsulated | ~0.05 to ~2 | ~0.07 to ~1.5 |
| fragrance, preferably having a | | |
| polyacrylate or biodegradable | | |
| shell (i.e., not formaldehyde- | | |
| releasing shells) | | |
| Dye | 0 to ~0.002 | ~0.0008 to ~0.0018 |
| Fragrance | 0 to ~2 | ~0.3 to ~1.5 |
| Water | q.s. | q.s. |

Three exemplary methods of making the disclosed compositions are provided in Example 1. The methods of making the disclosed compositions may be substantially free of any heating steps, providing for a more cost effective and safe manufacturing process. One of ordinary skill in the art will recognize that each cellulose material may have different hydration procedures and should follow the recommendations provided by the cellulose supplier in order to avoid having “fish-eye” clumps, or agglomerates, in the final formulation.

As shown in the examples that follow, the concentration of benzyl-substituted quaternary ammonium compounds may be reduced when specific polymers are added to the formulation and still provide equivalent germ kill to compositions containing higher concentrations of the benzyl-substituted quaternary ammonium compounds. Benzyl-substituted quaternary ammonium compounds are known to be toxic to aquatic environments. The ability to reduce the concentration of the benzyl-substituted quaternary ammonium compound is therefore beneficial. Additionally, the formulation does not require a large percentage of these polymers, which helps contain formulations costs. The polymer may be selected from the group consisting of poly(diallyldimethylammonium chloride) (PQ6) having a molecular weight <100 kDa (PQ6<100 kDa); PQ6 having a molecular weight ranging from 200 kDa to 300 kDa (PQ6 200-300 kDa); PQ6 having a molecular weight ranging from 400 kDa to 500 kDa (PQ6 400-500 kDa); copolymers of vinylpyrrolidone (VP) and quaternized vinylimidazole (QVI)(PQ16) having 5% wt VP and 95% wt QVI (PQ16 5VP-95QVI); PQ16 having 50% wt VP and 95% wt QVI (PQ16 50VP-50QVI); Poly(2-dimethylamino)ethyl methacrylate) methyl chloride quaternary salt (PQ37); 1-propanaminium, N,N,N-trimethyl-3-[(1-oxo-2-propenyl)amino] chloride, homopolymer (A1000); 1-dodecanaminium, N,N-dimethyl-N-[3-[(2-methyl-1-oxo-2-propen-1-yl)amino]propyl]-, chloride (1:1), polymer with sodium 2-methyl-2-[(1-oxo-2-propen-1-yl)amino]-1-propanesulfonate (1:1) and N,N,N-trimethyl-3-[(1-oxo-2-propen-1-yl)amino]-L propanaminium chloride (1:1) (C113); and combinations thereof

Alternative exemplary laundry compositions comprise approximately 2% wt to approximately 6% wt of a benzyl-substituted quaternary ammonium compound, approximately 0.25% wt to approximately 4% wt of the polymer, approximately 0.3% wt to approximately 1.5% wt of an alkylamine oxide, and approximately 0.4% wt to approximately 1% wt of phenoxyethanol.

Exemplary laundry compositions comprise:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1.5 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Water | q.s. | q.s. |

When used during the last rinse cycle of a laundry washing process, Applicants believe these laundry compositions obtain a 5 log₁₀ reduction as tested according to EN1276 and EN 1650 in Staphylococcus aureus, Enterococcus hirae, Escherichia coli, and Pseudomonas aeruginosa and a 4 log₁₀ reduction in Candida albicans. This means the above formulation qualifies as a laundry disinfectant composition under European regulations.

The laundry compositions may further comprise a fabric conditioner, which provides a softness effect to the fabric, for example to cotton fibers. The exemplary laundry compositions may comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Esterquat | ~2 to ~5 | ~3 to ~4 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1.5 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Esterquat | ~2 to ~5 | ~3 to ~4 |
| Water | q.s. | q.s. |

The laundry compositions may further comprise an enzyme, which may impart additional benefits to clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Enzyme | ~0.1 to ~4 | ~0.25 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1.5 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Enzyme | ~0.1 to ~4 | ~0.25 to ~1.5 |
| Water | q.s. | q.s. |

The laundry compositions may further comprise a cellulase enzyme, which may help keep clothes treated with the disclosed compositions looking new for longer. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulase (e.g., Celluclean ™ or | ~0.1 to ~1 | ~0.1 to ~0.75 |
| Carezyme Essential from | | |
| Novozymes) | | |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1.5 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulase (e.g., Celluclean ™ or | ~0.1 to ~1 | ~0.1 to ~0.75 |
| Carezyme Essential from | | |
| Novozymes) | | |
| Water | q.s. | q.s. |

The laundry compositions may further comprise a phosphodiesterase enzyme, which help remove body stains from clothes treated with the disclosed compositions. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Phospodiesterase (e.g., Pristine ™ | ~0.1 to ~4 | ~0.5 to ~2 |
| 100 L from Novozymes) | | |
| Water | q.s. | q.s. |

In another example, the exemplary laundry compositions comprise, consist essentially of, or consist of.

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1.5 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Phospodiesterase (e.g., Pristine ™ | ~0.1 to ~4 | ~0.5 to ~2 |
| 100 L from Novozymes) | | |
| Water | q.s. | q.s. |

The laundry compositions may further comprise an amylase and/or protease enzyme, which may help remove generic stains from clothes treated with the disclosed compositions, including enzymatic stains left behind by detergents. These enzymes help remove food for bacteria, which may cause bad smells. For example, these exemplary laundry compositions comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Protease (e.g., Progress | ~0.1 to ~4 | ~0.25 to ~0.75 |
| Uno from Novozymes) | | |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1.5 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Protease (e.g., Progress Uno from | ~0.1 to ~4 | ~0.25 to ~0.75 |
| Novozymes) | | |
| Water | q.s. | q.s. |

For aesthetic reasons, the laundry compositions may further comprise thickeners. The thickeners produce a composition having a viscosity ranging from 100 cPs to 500 cPs as measured using a Brookfield viscometer with LV62 spindle at 50 RPM at ambient temperature. For example, these exemplary laundry compositions comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Water | q.s. | q.s. |

Compositions that meet germ kill and other aesthetic parameters may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Enzyme | ~0.1 to ~4 | ~0.25 to ~1.5 |
| Dye | 0 to ~0.002 | ~0.0008 to ~0.0018 |
| Fragrance | 0 to ~2 | ~0.3 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Enzyme | ~0.1 to ~4 | ~0.25 to ~1.5 |
| Dye | 0 to ~0.002 | ~0.0008 to ~0.0018 |
| Fragrance | 0 to ~2 | ~0.3 to ~1.5 |
| Water | q.s. | q.s. |

Compositions that meet germ kill and help keep clothes looking new for longer may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Cellulase (e.g., Celluclean ™ or | ~0.1 to ~1 | ~0.1 to ~0.75 |
| Carezyme Essential from | | |
| Novozymes) | | |
| Dye | 0 to ~0.002 | ~0.0008 to ~0.0018 |
| Fragrance | 0 to ~2 | ~0.3 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Cellulase (e.g., Celluclean ™ or | ~0.1 to ~1 | ~0.1 to ~0.75 |
| Carezyme Essential from | | |
| Novozymes) | | |
| Dye | 0 to ~0.002 | ~0.0008 to ~0.0018 |
| Fragrance | 0 to ~2 | ~0.3 to ~1.5 |
| Water | q.s. | q.s. |

Compositions that meet germ kill and help remove body stains from clothes treated with the disclosed compositions may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Phospodiesterase (e.g., Pristine ™ | ~0.1 to ~4 | ~0.5 to ~2 |
| 100 L from Novozymes) | | |
| Dye | 0 to ~0.002 | ~0.0008 to ~0.0018 |
| Fragrance | 0 to ~2 | ~0.3 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Phospodiesterase (e.g., Pristine ™ | ~0.1 to ~4 | ~0.5 to ~2 |
| 100 L from Novozymes) | | |
| Dye | 0 to ~0.002 | ~0.0008 to ~0.0018 |
| Fragrance | 0 to ~2 | ~0.3 to ~1.5 |
| Water | q.s. | q.s. |

Compositions that meet germ kill and help remove generic stains from clothes treated with the disclosed compositions, including enzymatic stains left behind by detergents, may comprise, consist essentially of, or consist of:

| Ingredient | % wt | Preferable % wt |
|---|---|---|
| Benzyl-substituted quaternary | ~2 to ~8 | ~3 to ~7 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Protease (e.g., Progress Uno from | ~0.1 to ~4 | ~0.25 to ~0.75 |
| Novozymes) | | |
| Dye | 0 to ~0.002 | ~0.0008 to ~0.0018 |
| Fragrance | 0 to ~2 | ~0.3 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~2 to ~4 |
| ammonium compound | | |
| Alkylamine oxide | ~0.5 to ~1 | ~0.6 to ~1 |
| Phenoxyethanol | ~0.4 to ~1 | ~0.8 to ~1 |
| Citric acid | ~0.5 to ~1 | ~0.6 to ~0.9 |
| Non-aqueous solvent (e.g., EGHE) | ~0.1 to ~2 | ~0.5 to ~1.5 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Protease (e.g., Progress Uno from | ~0.1 to ~4 | ~0.25 to ~0.75 |
| Novozymes) | | |
| Dye | 0 to ~0.002 | ~0.0008 to ~0.0018 |
| Fragrance | 0 to ~2 | ~0.3 to ~1.5 |
| Water | q.s. | q.s. |

Formulations that provide germ kill, viscosity, and softness may comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Esterquat | ~2 to ~5 | ~3 to ~4 |
| Water | q.s. | q.s. |

These formulations remain clear, single phase solutions, particularly when the cellulose based thickener is 2-hydroxyethyl ether cellulose and the esterquat is a liquid N,N′-di(alkylcarboxyethyl)-N-hydroxyethyl-N-methylammonium methyl sulfate.

For aesthetic reasons, the laundry compositions may further comprise a suspending agent and an opacifier or encapsulated fragrance. Encapsulated fragrances in the laundry formulations helps fabrics remain fresh long after washing. For example, these exemplary laundry compositions comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Fermentation based suspending | ~1 to ~4 | ~1.5 to ~2.5 |
| agent (e.g., Cellulon ™ R93) | | |
| Opacifier and/or encapsulated | ~0.05 to ~2 | ~0.07 to ~1.5 |
| fragrance, preferably having a | | |
| polyacrylate or biodegradable shell | | |
| (i.e., not formaldehyde-releasing | | |
| shells) | | |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Citric acid | ~0.5 to ~1 | ~0.6 to ~0.9 |
| Polymer (e.g., PQ6, A1000, PQ16 | ~1 to ~3 | ~1.5 to ~2.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Opacifier and/or encapsulated | ~0.05 to ~2 | ~0.07 to ~1.5 |
| fragrance, preferably having a | | |
| polyacrylate or biodegradable shell | | |
| (i.e., not formaldehyde-releasing | | |
| shells) | | |
| Water | q.s. | q.s. |

In this embodiment, polyquaternium 37 may act as both a germ kill booster and suspending agent for the opacifier and/or encapsulated fragrance.

Dye and additional fragrance may be added to improve the aesthetic appeal of the resulting formulation. For example, these exemplary laundry compositions comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Propylene glycol | ~0.25 to ~1 | ~0.3 to ~0.75 |
| Citric acid | ~0.5 to ~1 | ~0.6 to ~0.9 |
| Sodium Hydroxide | ~0.01 to ~0.05 | ~0.02 to ~0.04 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Fermentation based suspending | ~1 to ~4 | ~1.5 to ~2.5 |
| agent (e.g., Cellulon ™ R93) | | |
| Opacifier and/or encapsulated | ~0.05 to ~2 | ~0.07 to ~1.5 |
| fragrance, preferably having a | | |
| polyacrylate or biodegradable shell | | |
| (i.e., not formaldehyde-releasing | | |
| shells) | | |
| Dye | 0 to ~0.002 | ~0.0008 to ~0.0018 |
| Fragrance | 0 to ~2 | ~0.3 to ~1.5 |
| Water | q.s. | q.s. |

In another example, the exemplary laundry compositions comprise, consist essentially of, or consist of:

| Ingredient | % wt | Preferable % wt |
|---|---|---|
| Benzyl-substituted quaternary | ~2 to ~6 | ~3 to ~5.5 |
| ammonium compound | | |
| Alkylamine oxide | ~0.3 to ~1.5 | ~0.4 to ~1 |
| Phenoxyethanol | ~0.4 to ~1 | ~0.5 to ~0.9 |
| Propylene glycol | ~0.25 to ~1 | ~0.3 to ~0.75 |
| Citric acid | ~0.5 to ~1 | ~0.6 to ~0.9 |
| Sodium Hydroxide | ~0.01 to ~0.05 | ~0.02 to ~0.04 |
| Polymer (e.g., PQ6, A1000, PQ16 | ~0.25 to ~4 | ~0.25 to ~1.5 |
| 5VP-95QVI, PQ16 50VP-50QVI, | | |
| PQ37, C113, or combos) | | |
| Cellulose based thickener | ~0.1 to ~0.5 | ~0.25 to ~0.45 |
| Opacifier and/or encapsulated | ~0.05 to ~2 | ~0.07 to ~1.5 |
| fragrance, preferably having a | | |
| polyacrylate or biodegradable shell | | |
| (i.e., not formaldehyde-releasing | | |
| shells) | | |
| Dye | 0 to ~0.002 | ~0.0008 to ~0.0018 |
| Fragrance | 0 to ~2 | ~0.3 to ~1.5 |
| Water | q.s. | q.s. |

In this embodiment, polyquaternium 37 may act as both a germ kill booster and suspending agent for the opacifier and/or encapsulated fragrance.

Liquid laundry products are also disclosed. The liquid laundry products comprise a container comprising any of the liquid laundry compositions disclosed above. Any container suitable for holding liquids may be used. The disclosed liquid laundry compositions may not trigger the requirement for child-resistant packaging under 40 C.F.R. § 157, subpart B. As a result, the container may not require a child-resistant cap. Child-resistant packaging is required if the formulation:
has an acute oral lethal dose of 1.5 g/kg or less;
has an acute dermal lethal dose of 2,000 mg/kg or less;
has acute inhalation of lethal concentration of 2 mg/L or less;
is corrosive to the eye (causing irreversible destruction of ocular tissue) or causes corneal involvement or irritation persisting for 21 days or more;
is corrosive to the skin (causing tissue destruction into the dermis and/or scarring) or causes severe skin irritation (severe erythema or edema) at 72 hours;
has such characteristics that, based upon human toxicological data, use history, accident data, or such other evidence as available, the EPA determines there is serious hazard of accidental injury or illness which child-resistant packaging could reduce.

Methods of sanitizing laundry during a laundry washing process using any of the disclosed compositions are also disclosed. The disclosed methods may further soften and or treat the fabrics being laundered. Exemplary fabrics include but are not limited to cotton, spandex, microfiber, polyester, rayon, nylon, lycra, or any combination thereof. About 25 mL to about 400 mL, preferably about 200 mL, of the disclosed compositions is added to the fabric softener compartment or directly to the rinse cycle of an automatic washing machine. The disclosed compositions are used in the last rinse cycle of the automatic washing machine process. Approximately 75 mL to approximately 180 mL is added to the fabric softener compartment or directly to the rinse cycle of a top loading washing machine that uses approximately 39 L per rinse. Approximately 125 mL to approximately 300 mL is added to the fabric softener compartment or directly to the rinse cycle of a top loading washing machine that uses approximately 47 L per rinse. Approximately 250 mL to approximately 350 mL is added to the fabric softener compartment or directly to the rinse cycle of a top loading washing machine that uses approximately 71 L per rinse. Approximately 300 mL to approximately 400 mL is added to the fabric softener compartment or directly to the rinse cycle of a top loading washing machine that uses approximately 89 L per rinse. Approximately 25 mL to approximately 100 mL is added to the fabric softener compartment of a front loading washing machine that uses approximately 17 L per rinse.

Some commercially available laundry sanitizers use larger dose sizes (>400 mL) to achieve germ kill with larger rinse water volumes in top-loading washing machines (e.g., 440 mL for Sample E in Example 8). By utilizing the disclosed composition, the disclosed synergies reduce the amount of active needed to deliver germ kill and provide more sustainable/concentrated formulations. The lower dosage volume as compared to Sample E also makes it easier for consumer to comply with dosing instructions.

The 1:262 dilution of the disclosed compositions with water achieves at least a 3 log₁₀ reduction (on a fabric carrier and within the wash liquor) according to the ASTM 2274 protocol, under clean conditions in no more than 30 minutes at 20° C. Preferably, the 1:262 dilution of the disclosed compositions with water achieves at least a 3 log₁₀ reduction (on a fabric carrier and within the wash liquor) in no more than 25 minutes at 20° C. As a result of this dilution capability, consumers may use the disclosed compositions in a large variety of rinse cycles having varying amounts of rinse water and still ensure that their clean laundry harbors fewer pathogens.

### EXAMPLES

The following examples illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

The compositions in the following examples were prepared using the ingredients identified in Table A:

TABLE A

| Abbreviation | CAS | Description |
|---|---|---|
| BKC | 68424-85-1 | C12-16 alkyldimethylbenzylammonium chloride, e.g., |
| | | BTC ™ 8358 (80% in ethanol and water) sold by Stepan |
| 2080 | 68424-95-3 | Blend of dioctyldimethylammonium chloride, |
| | | octyldecyldimethylammonium chloride, & |
| | | didecyldimethylammonium chloride e.g. BARDAC ™ 2080 |
| | | (80% pure in ethanol and water) sold by Arxada |
| 1010 | 7173-51-5 | Didecyldimethylammonium chloride e.g. BTC ™ 1010-80 |
| | | (80% pure in ethanol and water) sold by Stepan |
| 9EO | 68551-12-2 | Ethoxylated C12-16 Alcohols e.g., Genapol ™ LA 090 sold |
| | | by Clariant |
| WE | 157905-74-3 | Liquid N,N′-di(alkylcarboxyethyl)-N-hydroxyethyl-N- |
| | | methylammonium methyl sulfate, e.g., Rewoquat ™ WE 45 |
| | | (75% in ethanol) sold by Evonik |
| SLES | 68585-34-2 | Sodium lauryl ether sulfate e.g., Calfoam ™ ES-302 (27% |
| | | active) sold by Pilot |
| CocoB | 61789-40-0 | Cocoamidopropyl Betaine e.g., Galaxy ™ CAPB SB (30% |
| | | in water) sold by Tri-K Industries |
| APG | 110615-47-9 | Lauryl glucoside, e.g., Glucopon ™ 425n (50% in water) |
| | | sold by BASF |
| LO | 1643-20-5 | Lauramine oxide, e.g., Ammonyx ™ LO (30% in water) sold |
| | | by Stepan |
| MO | 3332-27-2 | Dimethyltetradecylamine Oxide, e.g., Ammonyx ™ MO |
| | | (30% in water) sold by Stepan |
| DO | 2605-79-0 | Decyl amine oxide, e.g. Ammonyx ™ DO (30% in water) |
| | | sold by Stepan |
| PG | 57-55-6 | Propylene glycol |
| DPG | 25265-71-8 | Dipropylene Glycol |
| DPNB | 5131-66-8 | Propylene Glycol n-butyl Ether, e.g., Dowanol ™ PnB sold |
| | | by Dow |
| EGHE | 112-25-4 | Ethylene glycol mono hexyl ether, e.g., Hexyl Cellosolve ™ |
| | | sold by Dow |
| HEC | 9004-62-0 | 2-Hydroxyethyl ether cellulose, e.g., Natrosol ™ 250 HHR |
| | | sold by Ashland (>94% in sodium sulfate) or Cellulon RC- |
| | | 76 sold by CP Kelco |
| PE | 122-99-6 | Phenoxyethanol, e.g., Protectol ™ PE NA sold by BASF |
| NaOH | 1310-73-2 | Sodium Hydroxide (50% in water) |
| CA | 77-92-9 | Citric Acid Anhydrous |
| D | Various | Various Dyes |
| F | Various | Various Fragrances |
| Encap | Various | Various encapsulated fragrances dispersed in a slurry, |
| | | preferably having a polyacrylate or biodegradable shell |
| | | (i.e., not formaldehyde-releasing shells) |
| H2O | 7732-18-5 | Water |
| OPR2 | 61789-40-0, | Cocamidopropyl betaine (7.5%) and glycol distearate |
| | 627-83-8, & | (30%), e.g., Miracare ™ OPR2, previously known as |
| | 532-32-1 | Mackadet ™ OPR2, sold by Solvay |
| PQ37 | 26161-33-1 | Polyquaternium-37 (50% active), e.g., Viscaress-PC-LQ |
| | | sold by Croda |
| R93 | 9004-34-665-85-0 | Mixture of fermentation derived cellulose and benzoic acid, |
| | | e.g., Cellulon ™ R93 sold by CP Kelco US Inc. |
| PQ6 | 26062-79-3 | Poly(diallyldimethylammonium chloride) e.g., |
| | | poly(DADMAC) <100 kDa (35% in water) or 200-300k or |
| | | 400-500k (both 20% in water), both sold by Sigma Aldrich; |
| | | or Dehyquart ™ CC 6 sold by BASF as CAS number 26062- |
| | | 79-3 (40% in water) |
| PQ7 | 26590-05-6 | Poly(acrylamide-co-diallyldimethylammonium chloride), |
| | | e.g., 10% solution sold by Sigma Aldrich |
| PQ16 | 95144-24-4 | Copolymers of vinylpyrrolidone (VP) and quaternized |
| | | vinylimidazole (QVI) (5VP-95QVI), e.g., Luviquat ™ |
| | | Excellence (38.42% in water) sold by BASF |
| PQ16 | 95144-24-4 | Copolymers of VP and QVI (50VP-50QVI), e.g., Luviquat ™ |
| | | FC550 (38% in water) sold by BASF |
| PQ16 | 95144-24-4 | Copolymers of VP and QVI (70VP-30VPI), e.g., Luviquat ™ |
| | | (38% in water) sold by BASF |
| A1000 | 26427-01-0 | 1-propanaminium, N,N,N-trimethyl-3-[(1-oxo-2-propenyl)amino] |
| | | chloride, homopolymer, e.g., N-Durhance ™ |
| | | A1000 (15-25% in water) sold by Ashland |
| PQ28 | 131954-48-8 | 2-pyrrolidinone, 1-ethenyl-, polymer with N,N,N-trimethyl- |
| | | 3-[(2-methyl-1-oxo-2-propenyl)amino]-1-propanaminium |
| | | chloride, e.g., Gafquat ™ HS-100 (15-25% in water) sold by |
| | | Ashland |
| C113 | 26427-33-1 | 1-dodecanaminium, N,N-dimethyl-N-[3-[(2-methyl-1-oxo- |
| | | 2-propen-1-yl)amino]propyl]-, chloride (1:1), polymer with |
| | | sodium 2-methyl-2-[(1-oxo-2-propen-1-yl)amino]-1- |
| | | propanesulfonate (1:1) and N,N,N-trimethyl-3-[(1-oxo-2- |
| | | propen-1-yl)amino]-L propanaminium chloride (1:1), e.g., |
| | | Chromohance ™ 113 (15-25% in water) sold by Ashland |

### Example 1

Exemplary laundry sanitizer and fabric conditioning formulations are provided in Table 1:

TABLE 1

| Abbreviation | E1 | E2 |
|---|---|---|
| BKC (80%) | 7.28 | 7.28 |
| | (5.82) | (5.82) |
| LO (30%) | 1.50 | 1.50 |
| | (0.45) | (0.45) |
| PE | 0.50 | 0.50 |
| WE (75%) | 4.50 | 4.50 |
| | (3.38) | (3.38) |
| PG | 0.50 | 0.50 |
| HEC | 0.30 | 0.33 |
| NaOH (50%) | 0.05 | 0.05 |
| | (0.025) | (0.025) |
| CA | 0.85 | 0.85 |
| D | 0.0018 | 0.0018 |
| F | 0.9 | 0.9 |
| H2O | 81.5182 | 80.0182 |
| OPR2 | 0.25 | 0.25 |
| PQ37 | 1.00 | 0 |
| | (0.5) | |
| Encap Slurry | 0 | 0.5 |
| R93 | 0 | 2.00 |

E1 was prepared by adding H2O to a tank with a mixer. The mixer was started. LO was added and mixed until homogeneous. PG was added and mixed until homogeneous. HEC was added and mixed until homogenous. The mixture became hazy/opaque after addition of HEC. The package containing the BKC raw material was mixed/shaken to ensure uniformity. The recently mixed/shaken BKC raw material is then added to the tank and mixed until homogeneous. The package containing the WE raw material was mixed/shaken to ensure uniformity. The recently mixed/shaken WE raw material is then added to the tank and mixed until homogeneous. PE was added and mixed until homogenous. NaOH was added and mixed until homogenous and then an additional 30 minutes to 90 minutes thereafter to ensure proper hydration of the HEC. The mixing for this step takes a little longer than prior mixing steps. The viscosity of the mixture increases significantly to approximately 200 cPs as measured after 60 seconds at 50 RPM using a LV62 spindle at ambient temperature. The hazy/opaque mixture also transforms to clear. Failure to provide sufficient NaOH mixing time may impact product stability. CA was added and mixed until homogeneous. The package containing the OPR2 raw material was mixed/shaken to ensure uniformity. The recently mixed/shaken OPR2 raw material was added and mixed until homogeneous. The formulation turned opaque. PQ37 was added and mixed until homogeneous. F and D were added and mixed until homogeneous. The final formulation was a light blue opaque liquid with a subtle shimmer effect when in motion.

E2 was prepared by adding H2O to a tank with a mixer. The mixer was started. LO was added and mixed until homogeneous. PG was added and mixed until homogeneous. The package containing the OPR2 raw material was mixed/shaken to ensure uniformity. The recently mixed/shaken OPR2 raw material was added and mixed until homogeneous. HEC was added and mixed until homogenous. The mixture became hazy/opaque after addition of HEC. NaOH was added and mixed until homogenous and then an additional 30 minutes to 90 minutes thereafter to ensure proper hydration of the HEC. The mixing for this step takes a little longer than prior mixing steps. The viscosity of the mixture increases significantly to approximately 200 cPs as measured after 60 seconds at 50 RPM using a LV62 spindle at ambient temperature. The hazy/opaque mixture also transforms to clear. Failure to provide sufficient NaOH mixing time may impact product stability. CA was added and mixed until homogeneous. The Encap is shaken to ensure uniformity & then is added and mixed until homogeneous. Add R93 and mix until homogeneous. Note that without any type of high shear mixing equipment inclusion of R93 at this stage may not yield a stable formulation. The package containing the BKC raw material was mixed/shaken to ensure uniformity. The recently mixed/shaken BKC raw material is then added to the tank and mixed until homogeneous. The package containing the WE raw material was mixed/shaken to ensure uniformity. The recently mixed/shaken WE raw material is then added to the tank and mixed until homogeneous. PE was added and mixed until homogenous. F and D were added and mixed until homogeneous. The final formulation was a light blue opaque liquid with a subtle shimmer effect when in motion.

No heating is needed for either process, providing for a more cost effective and safe manufacturing process.

Alternatively, E2 may be prepared by adding H2O to a tank with a mixer and starting the mixer. R93 is added and mixed for approximately 10 to approximately 30 minutes until homogeneous. To help achieve homogeneity, the mixing speed may be increased and/or the temperature of the water may be raised from approximately 70° F. (21° C.) to approximately 90° F. (32° C.). Once the R93 is homogeneously mixed in the water, the mixing speed is decreased to add HEC. No additional optional heating is used after addition of the R93. After all of the HEC is added, the mixture is mixed for approximately 10 to approximately 20 minutes. Care must be taken during addition of HEC to make sure no clumping (fish eyes) occurs. NaOH is added next and the resulting mixture is mixed for approximately 45 minutes to approximately 1 hour to ensure uniformity. The NaOH increases the thickness of the formulation and the mixing speed may be increased to compensate. An in-process viscosity sample is obtained and tested. Processing may continue after the sample demonstrates viscosity of 115 cps or higher as measured after 60 seconds at 50 RPM using a LV62 spindle at ambient temperature. Once the viscosity limitation is met, add PG and mix. Add CA and mix. Take an in-process sample to measure pH. Once the pH is 4 or less, shake the container of the optional Encap to ensure homogeneity and then add and mix for at least approximately 10 minutes. Take an in-process sample in a clear jar to ensure that the Encap is uniformly dispersed. Shake the package containing the BKC raw material to ensure uniformity. Add the recently mixed/shaken BKC raw material to the tank and mixed until homogeneous. Shake the package containing the WE raw material to ensure uniformity. The recently shaken WE raw material is then added to the tank and mixed until homogeneous. Add PE and mix until homogenous. Shake the package containing the OPR2 raw material to ensure uniformity. The recently mixed/shaken OPR2 raw material was added and mixed until homogeneous. Add LO and mix until homogeneous. Add F and mix until homogeneous. Add D and mix until homogeneous. Continue mixing for at least 20 minutes. After completing the batch, samples will need to be analyzed for:
Color, Odor, Appearance
pH
Specific Gravity
Viscosity
Active Content—Benzalkonium Chloride (analyzed via HPLC)
   Maintain the product in a closed storage tank until filling into bottles.

### Example 2

### Stability Tests

E1 was tested for stability alongside a competitor's fabric softener. According to the company's publicly available website, the commercial product contains diethylester dimethyl ammonium chloride, polyquaternium-33 (PQ33), formic acid, a blend of polyoxyalkylene substituted chromophores, pentasodium pentetate, fragrance, and water. The stability was quantified by observing color, odor, appearance, viscosity, & pH at key conditions (54° C. for 2 weeks, −10° C.—3 freeze thaw cycles). The results are provided in Table 2:

TABLE 2

| | | Laundry Sanitizer | | Fabric Softener Competitor | |
|---|---|---|---|---|---|
| Parameter | Success Criteria | 2 wks 54 C. | −10 (F + T)* | 2 wks 54 C. | −10 (F + T)* |
| color | No Change | Pass | Pass | Pass | Pass |
| odor | Only Slight Drops | Pass | Pass | Pass | Pass |
| appearance | No Change | Pass | Pass | Fail (Chunky) | Fail (Chunky) |
| viscosity | Must be pourable | Pass | Pass | Fail (Chunky) | Fail (Chunky) |
| pH | <0.5 pH unit | Pass | Pass | Pass | Pass |
| | deviation | | | | |

*F&T = Freeze/Thaw = 6 days only: 3 cycles of 24 hours each at −10° C. and 25° C.

These results demonstrate the improved stability of E1 as compared to a commercially available fabric conditioner emulsion system. Based on the chemical structure of PQ33, Applicant believes that PQ33 in the competitor's fabric softener would exhibit less antimicrobial synergy with the benzyl-substituted quaternary ammonium compound than PQ37 contained in formulation E1.

### Example 3—Antimicrobial Activity

The antimicrobial efficacy of the formulations in Table 3 was determined using ASTM E2274-16 entitled the Standard Test Method for Evaluation of Laundry Sanitizers and Disinfectants (version 15 Apr. 2016). A greater than 3 log₁₀ reduction of all organisms (Klebsiella pneumoniae, Staphylococcus aureus) on both the test fabric swatch & simulated wash water for a contact time of 1 to 60 minutes (determined by product specification) at a testing temperature ranging from 4° C. to 60° C.+1.0° C. (determined by product specification) is required to pass the ASTM E2274-16 for a sanitization product. For a disinfecting product, total kill must be achieved. Additional and optional contact times, temperatures, and test organisms may be used.

Microorganisms were subcultured on Nutrient Agar A (through at least one daily transfer), incubating at 35±2° C. On the day prior to testing, the slant was washed and cells transferred into French square bottles containing 20 mL of solidified Nutrient Agar B. The cells were then incubated between 18 to 24 hours at 35±2° C., agar side down. Growth was then removed using 3-mL dilution fluid and 5 sterile glass beads to suspend the growth. Cultures were then standardized to yield approximately 10⁸ CFUs per mL of S. aureus and 109 CFUs of K. pneumoniae.

The tests were performed using “clean” experimental conditions, which means no organic soil load was included for this test method. For laundry sanitizers/softeners, the desired experimental conditions are “clean conditions” because the laundry sanitizer/softener is used after a laundry detergent in a laundry washing process, i.e. on clean laundry.

As the test is designed to simulate killing bacteria on fabric, the test fabric also needs to be prepared. 300 g of test fabric was boiled for 1 hour in 3 L of deionized water containing 1.5 g NaCO₃ and 1.5 g nonionic wetting agent. The fabric was then rinsed in boiling water, then in cold water, until there was no longer the appearance of foam. The fabric was then air dried for 24 hours at room temperature. Once dry, the fabric was cut into 2 inch strips, weighing 15±0.1 grams each. The fabric was then secured onto a stainless steel spindle & wrapped precisely 12 times & then secured (as to represent laundry ballast). Furthermore, 1 by 1.5 inch fabric swatches were cut from the remaining fabric & used as carriers for microorganisms. At least 3 carriers were prepared for each organism tested. On the day of testing, these carriers were inoculated with 0.030 mL of prepared inoculum, taking care to distribute evenly across the 1 by 1.5 inch swatches. Swatches were dried in a 35±2° C. incubator for no longer than 30 minutes, and were used within 1 hour of drying. When ready, they were to be placed between the 6^{th} and 7^{th} folds of the simulated ballast, without any overlap of the swatches.

Experimentally, a 1:315 dilution of test substance was prepared in hard water (400 ppm CaCO₃) within 3 hours of testing. Approximately 150 mL of this test substance (simulated rinse water) was used to submerge the fabric carrier & ballast in a sterile exposure chamber that is agitated for the desired contact time. The test was allowed to proceed for 25 minutes and then the simulated rinse water and fabric carriers were separately neutralized. The carriers were then plated, and both plates/tubes are incubated for 48±2 hours at 35±2° C. The results were evaluated for sanitization (in terms of log₁₀ reduction) or for disinfection (positive or negative result for growth). Klebsiella pneumoniae was the organism selected for the experiment as it has typically provided a higher challenge than Staphylococcus aureus with these formulas in this method. The results are provided in Table 3:

TABLE 3

| Abbr | C1 | C2 | C3 | C4 | | E3 | E4 | E5 | E6 | E7 |
|---|---|---|---|---|---|---|---|---|---|---|
| 2080 | 0 | 4.4 (3.52) | 6.9 (5.52) | 4.12 | (3.23) | 0 | 0 | 0 | 0 | 0 |
| (80%) | | | | | | | | | | |
| 1010 | 4.4 (3.52) | 0 | 0 | 0 | | 0 | 0 | 0 | 0 | 0 |
| (80%) | | | | | | | | | | |
| BKC | 0 | 2.9 (2.32) | 0 | 2.75 | (2.2) | 6.9 (5.52) | 6.6 (5.28) | 6.67 (5.34) | 6.67 (5.34) | 6.67 (5.34) |
| (80%) | | | | | | | | | | |
| LO | 1.50 (0.45) | 1.50 (0.45) | 1.5 (0.45) | 1.5 | (0.45) | 1.5 (0.45) | 1.5 (0.45) | 1.5 (0.45) | 1.5 (0.45) | 1.5 (0.45) |
| (30%) | | | | | | | | | | |
| PE | 0.5 | 0.5 | 0.5 | 0.5 | | 0.5 | 0.5 | 0.5 | 0.5 | 0.5 |
| WE | 2 (1.5) | 4 (3) | 4 (3) | 4.5 | (3.38) | 4.5 (3.38) | 4.5 (3.38) | 4.5 (3.38) | 4.5 (3.38) | 4.5 (3.38) |
| (75%) | | | | | | | | | | |
| PG | 0 | 0 | 0 | 0.5 | | 0.5 | 0.5 | 0.5 | 0.5 | 0.5 |
| HEC | 0.3 | 0.35 | 0.35 | 0.35 | | 0.35 | 0.35 | 0.35 | 0.35 | 0.35 |
| NaOH | 0.045 (0.02) | 0.05 (0.02) | 0.05 (0.02) | 0.05 | (0.02) | 0.05 (0.02) | 0.05 (0.02) | 0.05 (0.02) | 0.05 (0.02) | 0.05 (0.02) |

| | | | | | | | | | |
|---|---|---|---|---|---|---|---|---|---|
| (50%) | | | | | | | | | |
| CA | 0.85 | 3 | 3 | 0.85 | 0.85 | 0.85 | 0.85 | 0.85 | 0.85 |
| OPR2 | 0 | 0 | 0 | 0.25 | 0.25 | 0.25 | 0.25 | 0.25 | 0.25 |
| PQ37 | 0 | 0 | 0 | 0 | 0 | 0.5 (0.25) | 1 (0.5) | 1 (0.5) | 0 |
| R93 | 0 | 0 | 0 | 0 | 0 | 0 | 0 | 0 | 2 |
| Encap | 0 | 0 | 0 | 0 | 0 | 0 | 0 | 0 | 0.5 |
| F | 0 | 0 | 0 | 0 | 0 | 0 | 0 | 0.8 | 0.9 |
| D | 0 | 0 | 0 | 0 | 0 | 0.0018 | 0.0018 | 0.0018 | 0.0018 |
| H2O | q.s. | q.s. | q.s. | q.s. | q.s. | q.s. | q.s. | q.s. | q.s. |
| Swatch | 0.42 | Total | 2.1 | 4.19 | Total | Total | 3.35 | Total | 4.32 |
| Result | | Kill | | | Kill | Kill | | Kill | |
| Wash | 3.97 | Total | Total | Total | Total | Total | Total | Total | Total |
| Water | | Kill | Kill | Kill | Kill | Kill | Kill | Kill | Kill |
| Result | | | | | | | | | |

These results demonstrate that BKC is more efficacious than Dialkyl Dimethyl Ammonium Chlorides (DDAC or 2080 and 1010) alone (at an equivalent level). The results also suggest that BKC alone is performing the same or better than a blend of BKC and DDAC in this test system. Finally, these results demonstrate that the concentration of BKC can be lowered by addition of PQ37 (E4 and E6) and still obtain germ kill equivalent to that obtained from a higher concentration of BKC (E3).

For context, it is typically observed in the ASTM 2274 method that meeting success criteria on the swatch is more challenging than in the wash water, which may explain the discrepancy between E5 and E6. This is likely due to mobility of the active agents and their ability to penetrate deep into the simulated ballast to reach the inoculated fabric carriers. Inversely, the simulated rinse water is similar to a solution, where there is little interference between the active substance and any particles suspended therein.

### Example 4—Micro Efficacy Synergy—Phenoxyethanol with BKC

The antimicrobial efficacy of the formulations in Table 4 was determined against K. pneumoniae using ASTM E2274-16 entitled the Standard Test Method for Evaluation of Laundry Sanitizers and Disinfectants (version 15 Apr. 2016), as described in Example 3.

TABLE 4

| Formula | C5 | | E8 | | E9 | | E10 | | E11 | |
|---|---|---|---|---|---|---|---|---|---|---|
| BKC (80%) | 7.25 | (5.8) | 7.25 | (5.8) | 6.875 | (5.5) | 3.7968 | (3.0) | 3.8662 | (3.1) |
| DO (30%) | 1.50 | (0.45) | 1.50 | (0.45) | 1.50 | (0.45) | 2 | (0.6) | 0 | |
| LO (30%) | 0 | | 0 | | 0 | | 0 | | 2 | (0.6) |
| PE | 0 | | 0.5 | | 0.9 | | 0.9 | | 0.9 | |
| PG | 0.5 | | 0.5 | | 0.5 | | 0.5 | | 0.5 | |
| PQ6 | 1.0 | (0.4) | 1.0 | (0.4) | 1.0 | (0.4) | 1 | (0.4) | 1 | (0.4) |
| EGHE | 1.0 | | 1.0 | | 1.0 | | 1.0 | | 1.0 | |
| NaOH | 0.05 | (0.02) | 0.05 | (0.025) | 0.05 | (0.025) | 0.05 | (0.025) | 0.05 | (0.025) |

| (50%) | | | | | |
|---|---|---|---|---|---|
| CA | 0.85 | 0.85 | 0.85 | 0.85 | 0.85 |
| HEC | 0 | 0 | 0 | 0.4 | 0.4 |
| H2O | q.s. | q.s. | q.s. | q.s. | q.s. |
| Swatch | 3.03 | 4.46 | 3.66 | 3.89 | 4.22 |
| Result | | | | | |
| Wash Water | Total Kill | Total Kill | Total Kill | Total Kill | Total Kill |
| Result | | | | | |

The results in Table 4 demonstrate that increasing phenoxyethanol improves the micro efficacy of quat-based formulas in swatch results. Formula C5 did not contain phenoxyethanol while E8 and E9 contained increasing amounts of phenoxyethanol. Formula E9 showed a decrease in efficacy in swatch results because the BKC level was reduced, but it still shows an improvement over C5.

Table 4 further demonstrates that increasing both the amine oxide and phenoxyethanol in formulas E10 and E11 further improves efficacy. E10 and E11 increased amine oxide (DO and LO) and permitted significant reduction in BKC concentration with similar germ kill.

### Example 5—Micro Efficacy Synergies—Amphoteric Surfactants with BKC

The antimicrobial efficacy of the raw materials in Table 5 were screened using F.A.S.T. (Fast Antimicrobial Screening Technology) against Staphylococcus aureus and Pseudomonas aeruginosa. F.A.S.T. is a modified test method based on EN1276. It is a quicker test method that runs many test products simultaneously per plate and can be used for feasibility studies. For the purposes of our test methods, the turbidity method was utilized. A 96 well plate was set up and neutralizer media was pipetted into column 2 of the plate. Growth media was pipetted into columns 3-12. A control of either AOAC or EN lab purified sterile water was added to column 1 in at least duplicates. Test products were added to open rows in column 1 in at least duplicates. Up to 4 products, including the control, can be tested on a single plate. Bacterial suspension was mixed with certain conditions depending on product usage. To mimic the laundry rinse cycle, solutions were kept around 20° C. and 0.3 g/L bovine albumin was added to the bacterial suspension, After 2 minutes, the bacteria solution was transferred into wells in column 1 using a multi-channel pipet. The solutions in each well were mixed by pipetting up and down. After the designated contact time has expired, column 1 solutions were transferred into the wells with neutralizer and pipet to mix. A contact time of 25 minutes was used to mimic the laundry rinse cycle. The neutralized solution was then transferred in column 3 with growth media and mixed. Solutions in column 3 were then serially diluted 1:10 into the remaining wells with growth media. The plate was covered and added to an incubator overnight. Wells that show turbidity were used to estimate bacteria log₁₀ reduction. The Spearman-Karber method (Eq. 1) was used to calculate the log₁₀ recovery.

$${Log}_{10} recovery = Highest dilution ( HD ) with both positives - 0.5 + ( sum of positive wells at HD and up ) / 2. \qquad ( Eq . 1 )$$

TABLE 5

| Formula | C6 | C7 | C8 | C9 | C10 |
|---|---|---|---|---|---|
| 9EO | 6.58 (6.25) | 0 | 0 | 0 | 0 |
| SLES | 0 | 23.58 (6.25) | 0 | 0 | 0 |
| CocoB | 0 | 0 | 6.58 (6.25) | 0 | 0 |
| APG | 0 | 0 | 0 | 12.39 (6.25) | 0 |
| LO (30%) | 0 | 0 | 0 | 0 | 21.26 (6.25) |
| H2O | q.s. | q.s. | q.s. | q.s. | q.s. |
| Staphylococcus | 0 | 0 | 0 | 0 | 2 |
| aureus log₁₀ | | | | | |
| reduction | | | | | |
| Pseudomonas | 0 | 0 | 0 | 0 | 0 |
| aeruginosa | | | | | |
| log₁₀ reduction | | | | | |

Table 5 demonstrates that most surfactants do not contribute to micro efficacy, but some amphoteric surfactants such as Lauramine Oxides may contribute to reducing bacteria levels. The samples targeted 6.25% wt in solution and were further diluted during testing to a final active level of about 5%. Only the sample with Lauramine Oxide showed a log₁₀ reduction against Staphylococcus aureus. Findings from this study were utilized in full laundry sanitizer formulas.

The antimicrobial efficacy of formulas in Table 6 utilized ASTM E2274-16 entitled the Standard Test Method for Evaluation of Laundry Sanitizers and Disinfectants (version 15 Apr. 2016), as described in Example 3.

TABLE 6

| Formula | E12 | E13 | E14 | E15 | E16 |
|---|---|---|---|---|---|
| BKC (80%) | 7.25 (5.8) | 7.25 (5.8) | 7.25 (5.8) | 6.875 (5.5) | 6.875 (5.5) |
| LO (30%) | 1.5 (0.45) | 0 | 0 | 0 | 0 |
| DO (30%) | 0 | 1.5 (0.45) | 0 | 1.5 (0.45) | 2.0 (0.6) |
| MO (30%) | 0 | 0 | 1.5 (0.45) | 0 | 0 |
| PE | 0.5 | 0.5 | 0.5 | 0.5 | 0.5 |
| PG | 0.5 | 0.5 | 0.5 | 0.5 | 0.5 |
| PQ6 | 0 | 0 | 0 | 1.0 (0.4) | 1.0 (0.4) |
| EGHE | 2.0 | 2.0 | 2.0 | 1.0 | 1.0 |
| NaOH (50%) | 0.05 (0.02) | 0.05 (0.025) | 0.05 (0.025) | 0.05 (0.025) | 0.05 (0.025) |
| CA | 0.85 | 0.85 | 0.85 | 0.85 | 0.85 |
| H2O | q.s. | q.s. | q.s. | q.s. | q.s. |
| Swatch Result | 2.54 | 3.34 | 3.29 | 1.81 | 4.16 |
| (K. pneumoniae) | | | | | |
| Wash Water Result | Total Kill | Total Kill | Total Kill | 1.48 | Total Kill |
| (K. pneumoniae) | | | | | |

Table 6 demonstrates how amphoteric surfactants improve the micro efficacy of quat-based formulas. Formulas E12, E13, and E14 contained LO, DO, or MO, respectively, and demonstrated some micro efficacy against K. pneumoniae, with MO and DO both achieving passing results of >3 log₁₀. Formulas E15 and E16 both reduced the quat to 5.5%, but Formula E16 increased the DO surfactant level to 0.6%, resulting in a significant increase of efficacy.

### Example 6—Micro Efficacy Synergies—Solvents

The antimicrobial efficacy of the formulations in Table 7 was determined using ASTM E2274-16 entitled the Standard Test Method for Evaluation of Laundry Sanitizers and Disinfectants (version 15 Apr. 2016), as described in Example 3. The organism selected for testing was Klebsiella pneumoniae.

TABLE 7

| Formula | E17 | | E18 | | E19 | | E20 | | E21 | |
|---|---|---|---|---|---|---|---|---|---|---|
| BKC (80%) | 7.8125 | (6.25) | 7.8125 | (6.25) | 7.25 | (5.8) | 6.625 | (5.3) | 6.625 | (5.3) |
| LO (30%) | 1.50 | (0.45) | 1.50 | (0.45) | 0 | | 0 | | 0 | |
| DO (30%) | 0 | | 0 | | 1.5 | (0.45) | 2 | (0.6) | 2 | (0.6) |
| PE | 0.5 | | 0.5 | | 0.5 | | 0.9 | | 0.9 | |
| PG | 0.5 | | 0.5 | | 0.5 | | 0.5 | | 0.5 | |
| PQ6 | 0 | | 0 | | 1.0 | (0.4) | 1.0 | (0.4) | 1.0 | (0.4) |
| DPNB | 2.0 | | 0 | | 0 | | 0 | | 0 | |
| EGHE | 0 | | 2.0 | | 1.0 | | 1.0 | | 0 | |
| DPG | 0 | | 0 | | 0 | | 0 | | 1.0 | |
| NaOH (50%) | 0.05 | (0.02) | 0.05 | (0.02) | 0.05 | (0.025) | 0.05 | (0.025) | 0.05 | (0.025) |

| CA | 0.85 | 0.85 | 0.85 | 0.85 | 0.85 |
|---|---|---|---|---|---|
| H2O | q.s. | q.s. | q.s. | q.s. | q.s. |
| Swatch Result | 2.28 | Total Kill | 4.46 | 4.25 | 2.73 |
| Wash Water Result | Total Kill | Total Kill | Total Kill | Total Kill | Total Kill |

Table 7 demonstrates that certain solvents boost micro efficacy. Formula E17 showed failing results against K. pneumoniae. The micro result improved significantly after substituting the DPNB solvent of E17 with EGHE of E18. Formula E19 and E20 utilized all micro efficacy synergies reported in this application to show that a combination of the EGHE solvent with PQ6 and DO allows further reduction of the quat levels. Formula E20 and E21 show the decrease in micro efficacy when the ethylene glycol monohexyl ether solvent of E20 is substituted with DPG of E21.

### Example 7—Softness

Formulation E1 from Example 1 above was tested against existing laundry products, including two laundry softeners, a laundry detergent and a laundry sanitizer. The publicly available ingredients for the existing products is provided in Table 8 below. The test was performed utilizing a modified version of ASTM D5237-14 “Standard Guide for Evaluating Fabric Softeners (modified)”.

TABLE 8

| Sample | Description |
|---|---|
| A | commercially available fabric softener containing: diethylester |
| | dimethyl ammonium chloride, polyquaternium-33, formic acid, |
| | blend of polyoxyalkylene substituted chromophores, and |
| | pentasodium pentetate, and fragrance (same as Example 2) |
| B | commercially available laundry detergent containing: C12-15 |
| | alcohols ethoxylated; sodium laureth sulfate; sodium carbonate, |
| | alcohol, tetrasodium iminodisuccinate, sodium cocoate, sodium |
| | polyacrylate, fluorescent brightener 5, benzisothiazolinone |
| C | commercially available laundry sanitizer containing: Octyl decyl |
| | dimethyl ammonium chloride, dodecyl dimethyl ammonium |
| | chloride, dioctyl dimethyl ammonium chloride, C14-16 alkyl |
| | dimethyl ammonium chloride, water, C10-16 pareth, fragrance, |
| | sodium bicarbonate, sodium carbonate, colorant |
| D | commercially available fabric softener |
| | containing: water, citric acid, |
| | propylene glycol, sodium formate, C12-16 pareth-9, sodium |
| | cumenesulfonate, fragrance |
| E | commercially available laundry |
| | sanitizer containing: water, Alkyl |
| | C12-16 dimethylbenzyl ammonium chloride, decylamine oxide, |
| | quaternium-24, sodium chloride, ethanol, didecyldimonium |
| | chloride, dimethyldioctylammonium |
| | chloride, hydroxytheylcellulose, |
| | syrups/hydrolyzed starch/polymers with acrylic acid and maleic |
| | anhydride, sodium salt, hydrogen peroxide, and peroxydisulfuric |
| | acid, decyldimethylamine, hydrogen peroxide, sodium acetate, |
| | isopropanol, polyoxyalkylene substituted chromophore |

### Method

A fabric bundle consisting of 100% cotton towels were washed with laundry detergent and then treated with the test product during the machine's rinse cycle. All samples were washed with 6 lbs of 100% cotton ballast. After wash/rinse completion, towels were dried on a “permanent press” machine setting. Once complete, they were allowed to equilibrate to ambient temperature & humidity. All products were tested considering their dosage recommendation for a “medium” load of laundry.

Twenty (20) individual panelists evaluated the blinded samples in a randomized order. Prior to evaluations, each panelist was instructed to wash and dry hands. If re-evaluations were needed, panelists were instructed to evaluate different sections of the towel. Panelists were presented with a group of five test fabrics on a table, with each fabric presented randomly and containing a different treatment and a blinded negative control. Each of the substrates were then assigned a softness rating on a scale of 1 to 5, with 5 being extremely soft, and 1 being extremely rough. The evaluations were all completed within the span of 2 hours. After evaluating the substrates, panelists were also instructed to evaluate the liking of this softness more holistically as to minimize any introduced bias (as it is known that imparting softness can sometimes deliver unintended consequences . . . e.g. a greasy or slick feeling, reduced absorbency, etc.) All data and results can be found below in Tables 9 and 10.

TABLE 9
Softness Rating Results

| Subject | A | B | C | D | E |
|---|---|---|---|---|---|
| 1 | 1 | 2 | 3 | 4 | 5 |
| 2 | 2 | 2 | 3 | 2 | 4 |
| 3 | 3 | 2 | 3 | 2 | 4 |
| 4 | 4 | 3 | 4 | 3 | 3 |
| 5 | 4 | 4 | 4 | 4 | 4 |
| 6 | 3.5 | 2 | 3 | 3.5 | 3.5 |
| 7 | 2 | 2 | 2 | 2 | 2 |
| 8 | 2 | 3 | 4 | 3 | 5 |
| 9 | 3 | 3 | 4 | 2 | 5 |
| 10 | 4 | 1 | 3 | 1 | 5 |
| 11 | 3 | 2 | 2 | 2 | 3 |
| 12 | 3 | 1 | 3 | 3 | 5 |
| 13 | 2 | 1 | 4 | 3 | 5 |
| 14 | 4 | 3 | 3 | 3 | 5 |
| 15 | 3 | 2 | 4 | 3 | 5 |
| 16 | 5 | 1 | 2 | 3 | 5 |
| 17 | 4 | 1 | 3 | 3 | 5 |
| 18 | 3 | 2.5 | 3 | 2.5 | 4 |
| 19 | 3 | 2 | 3 | 2 | 3 |
| 20 | 3 | 1 | 3 | 4 | 5 |
| Average | 3.075 | 2.0 | 3.2 | 2.8 | 4.3 |

TABLE 10
Softness Liking Results

| Subject | A | B | C | D | E |
|---|---|---|---|---|---|
| 1 | 1 | 1 | 2 | 4 | 5 |
| 2 | 1 | 1 | 3 | 1 | 5 |
| 3 | 3 | 2 | 3 | 2 | 4 |
| 4 | 5 | 4 | 5 | 4 | 4 |
| 5 | 4 | 4 | 4 | 4 | 4 |
| 6 | 4 | 2 | 3.5 | 4 | 4 |
| 7 | 2 | 2 | 2 | 2 | 2 |
| 8 | 1 | 2 | 4 | 3 | 5 |
| 9 | 3 | 3 | 3 | 3 | 5 |
| 10 | 4 | 1 | 3 | 1 | 5 |
| 11 | 4 | 3 | 3 | 3 | 4 |
| 12 | 4 | 1 | 3 | 4 | 5 |
| 13 | 2 | 1 | 4 | 3 | 5 |
| 14 | 4 | 4 | 4 | 4 | 5 |
| 15 | 2 | 1 | 5 | 2 | 5 |
| 16 | 4 | 1 | 3 | 2 | 5 |
| 17 | 4 | 1 | 3 | 1 | 5 |
| 18 | 2 | 2 | 3 | 2 | 4 |
| 19 | 3 | 2 | 3 | 2 | 3 |
| 20 | 5 | 1 | 4 | 4 | 5 |
| Average | 3.1 | 2.0 | 3.4 | 2.8 | 4.5 |

### Results

At a 95% confidence interval, it was shown that the test product E1 delivered significantly higher ratings versus all other products in terms of both softness & liking of the softness. Softness is the tactile perception of softness, so the fabric may be either soft or rough. Liking of softness measures consumers expectations, meaning sometimes softness may include a greasy feeling which consumers may not like. Therefore, a consumer may rate something as soft, but still not like it because they also perceive a greasy feeling. A higher “perception of softness” score is important for consumers to feel like their clothes are clean and fresh.

### Example 8—BKC PQ Antimicrobial Synergy

### Inoculum Preparation:

Take well-defined and typical colonies of Staphylococcus epidermidis from a recent plate of tryptic soy agar (TSA), dissolve and vortex them in a tube containing 30 mL of tryptic soy broth (TSB) and incubate for 17+/−1 h at 37° C.+/−1° C. Quantify by plate count in TSA (incubated for 48 h+/−1 h at 37° C.+/−1° C.). Use the broth culture suspension within seven (7) days after the incubation period. Vortex and take 0.2 mL from the broth culture and dilute in appropriate volume of 0.85% NaCl to normalize the strain at 3-5×10\hat{ }5 CFU/mL

### Test Sample Gradient Creation:

Using a micropipette, add 100 μL of TSB in a 96-well microtiter plate format.

Dispense 100 μL of the test sample (polymer) in column 1 (from row A to row H depending on the number of test samples) and 100 μL of the same test sample (polymer) in column 2 in their respective rows within 30 minutes of preparing the solution if it has been previously diluted. (both samples are the same)

Using a micropipette take 100 μL of the sample from column 2 and dilute it in column 3 performing a 1:1 dilution with the diluent already present in the wells, proceeding with a serial dilution up to column 9. Discard the remaining 100 μL.

### Inoculum:

Within 30 minutes of preparing the gradient and inoculum bacterial suspension, dispense 20 μL of a solution of BKC in the wells from columns 2 to 9. Dispense 100 μL of inoculum using a micropipette into each well in columns 2 to 10. Columns 1 and 11 are the sample sterility test and negative test control columns, respectively. No growth should be observed in these columns. Column 10 is the positive test control and growth should be observed.

To test the polymers antimicrobial activity alone (without BKC) repeat the steps above, without the addition of the 20 μL solution of BKC.

The inoculum must be between 2.5-4.5×10\hat{ }5 CFU/mL in each well.

Incubate the microwell plate for 24 h+/−1 h at 37° C.+/−1° C.

The minimum inhibitory concentration (MIC) is determined by visually checking the wells for growth. The MIC is defined as the minimal concentration of polymer in the corresponding well without visible growth after 24 hours of incubation. The tests were performed two times for most of the listed polyquaternium polymers. The MIC of BKC alone ranged from 5-8 ppm or 0.3-0.8 ppm in R&D test conditions. One of ordinary skill in the art will recognize that micro testing is not an exact science and results may vary significantly, especially in R&D test conditions. However, these results demonstrate the consistent synergy or lack of synergy between BKC and the polymers. The results are provided in Table 11:

TABLE 11

| | BKC MIC in | BKC MIC in ppm | Polymer MIC in | Polymer MIC in |
|---|---|---|---|---|
| | ppm alone | with polymer | ppm with BKC | ppm alone |
| PQ6 <100 | 5-8 | 4 | 0.8 | 6.25-40 |
| kDa | 0.3-0.8 | 0.075 | 2 | 7.8 |
| PQ6 | 5-8 | 4 | 0.8 | 6.25-40 |
| 200-300 kDa | 0.3-0.8 | 0.075 | 2 | 7.8 |
| PQ6 | 5-8 | 4 | 0.8 | 6.25-40 |
| 400-500 kDa | 0.3-0.8 | 0.075 | 3.9 | 15.6 |
| PQ7 | 5-8 | 4 | 39 | 1250 |
| | 0.3-0.8 | 0.075 | 250 | >250 |
| PQ16 | 5-8 | 4 | 0.8 | 8-12.5 |
| 5VP-95QVI | 0.3-0.8 | 0.075 | 3.9 | 15.6 |
| PQ16 | 5-8 | 4 | 0.8 | 25-47 |
| 50VP-50QVI | 0.3-0.8 | 0.075 | 15.6 | 62.5 |
| PQ16 | 5-8 | 4 | 39 | 1250 |
| 70VP-30QVI | 0.3-0.8 | 0.075 | >250 | >250 |
| A1000 | 5-8 | 4 | 0.8 | 12-16 |
| | 0.3-0.8 | 0.075 | 3.9 | 23.4 |
| PQ28 | 5-8 | 4 | 0.8 | >2500 |
| | 0.3-0.8 | 0.075 | >250 | >250 |
| C113 | 5-8 | 4 | 0.8 | 12.5-16 |
| | 0.3-0.8 | 0.075 | 3.9 | 31.2 |
| PQ37 | 5-8 | 4 | N/A | 31 |
| | 0.3-0.8 | 0.075 | 15.6 | 31.2 |

*All ppm show 100% wt concentration of active, not % wt raw material
**N/A = not analyzed

As shown in Table 11 above, all 3 kDa of PQ6, PQ16 5VP-95QVI, A1000, and C113 exhibit excellent synergy with BKC, especially PQ6<100 kDa and PQ6 200-300 kDa. The combinations permit the disclosed disinfecting concentrations to significantly reduce the quantity of BKC without adding a large quantity of the polymer to the disinfecting compositions.

PQ16 50VP-50QVI and PQ37 also demonstrate synergy, but require a larger quantity of polymer to do so.

PQ7, PQ16 70VP-30VPI and PQ28 require a large quantity of polymer to increase the efficacy of BKC. And BKC is inexpensive. As a result, these polyquaternium polymers may be undesirable to use to increase the germ kill of benzyl-substituted quaternary ammonium compounds, especially if they are toxic to aquatic environment.

### Example 9—Micro Efficacy Synergies—PQ6

The antimicrobial efficacy of the formulations in Table 12 was determined using ASTM E2274-16 entitled the Standard Test Method for Evaluation of Laundry Sanitizers and Disinfectants (version 15 Apr. 2016), as described in Example 3.

TABLE 12

| Formula | E22 | | E23 | | E24 | |
|---|---|---|---|---|---|---|
| BKC (80%) | 8.125 | (6.5) | 7.25 | (5.8) | 7.8125 | (6.25) |
| LO (30%) | 1.50 | (0.45) | 1.50 | (0.45) | 1.50 | (0.45) |
| PE | 0.5 | | 0.5 | | 0.5 | |
| PG | 0.5 | | 0.5 | | 0.5 | |
| PQ6 | 0 | | 1.0 | (0.4) | 1.0 | (0.4) |
| NaOH (50%) | 0.05 | (0.02) | 0.05 | (0.02) | 0.05 | (0.02) |

| CA | 0.85 | 0.85 | 0.85 |
|---|---|---|---|
| H2O | q.s. | q.s. | q.s. |
| Swatch Result | 2.67 | 2.38 | Total Kill |
| Wash Water Result | Total Kill | Total Kill | Total Kill |

Table 12 demonstrates that adding PQ6 boosts the micro efficacy of the formula. By adding 0.4% active amount of PQ6 to Formula E23, the amount of quat was reduced by 0.7% and achieved a similar micro result. Formula E24 also shows a significant improvement in micro efficacy with a reduced quat concentration of 0.25% and added 0.4% PQ6 compared to Formula E22. Because many quats used for germ kill can add corrosivity or environmental hazards to a product, finding synergies such as PQ6 can lead to better optimized formulations.

### Example 10—Moisture Wicking

The ability of fabrics to absorb moisture was evaluated by pipetting 5 water droplets onto pre-treated fabrics & noting the amount of time it takes to absorb the droplets into the fabric—full absorption being considered as the moment there is no longer a visible “dome” shape from the water resting on top of the fabrics.

Fabrics were treated by performing 5 washes in a Whirlpool™ top-load washing machine (using separate machines for each test product & control). The machine was set to medium agitation, warm water, normal wash cycle, no pre-treatment, and 1 rinse+fabric softener settings. In each machine, 6 lbs (2.7 kg) of ballast (typically including cotton towels & t-shirts) were used in combination with polyester/spandex blend women's leggings. To perform a wash, 45 mL of dye & scent-free detergent was added directly to the washing machine drum, then the ballast & leggings were added on top. The machine was started and allowed to proceed through the wash cycle. Once the machine entered the rinse cycle, 150 mL of E1 from Example 1, 150 mL of E2 from Example 1, or 90 mL of Sample A from Example 7 was added. After adding the products, the machine was allowed to complete the remainder of the laundry cycle. The leggings & ballast were then dried in a Samsung™ dryer on the “permanent press” setting with sense dry. After drying, the entire process was repeated a total of 4 more times to complete 5 total washes.

Success on this test was achieved by needing <5 seconds for the water droplets to be absorbed onto the test fabric (validated by a control sample that was treated only with detergent and no test product). The leggings tested with the disclosed compositions and control met the success criteria, indicating that the moisture absorption of the fabric was not impeded. The leggings treated with traditional fabric conditioner, however, did require >5 seconds for the water droplets to be absorbed, indicating that the moisture absorption ability of the leggings was impaired.

### Example 11—Bovine Corneal Opacity & Permeability Testing & Need for Child Resistant Closure

Under US EPA guidance, formulations will need a child resistant closure if any of the following conditions are met: an acute oral LD50 of 1.5 g/kg or less, an acute dermal LD50 of 2000 mg/kg or less, an acute inhalation LC50 of 2 mg/liter or less, corrosivity to the eye (or causes corneal involvement/irritation persisting for 21 days or more), corrosivity to the skin or causes sever skin irritation (severe erythema or edema) at 72 hours, or if the agency has enough evidence otherwise to suggest a child resistant closure is necessary. A key challenge for laundry sanitizers is the assessment of eye corrosivity. Multiple in-market laundry sanitizers sold in the US are required to have child resistant closures either due to eye corrosivity or a combination of eye corrosivity and one of the other parameters listed above. To evaluate eye corrosivity, in vivo testing can be conducted. However, the EPA also allows in vitro testing to predict eye corrosivity. The in vitro eye corrosivity test method approved by the EPA is from the Organisation for Economic Cooperation and Development (OECD) Method 437 titled Bovine Corneal Opacity and Permeability Testing.

In OECD 437, EPA toxicity categories are defined in terms of the IVIS (in vitro irritancy score)—scores of less than 25 are an EPA category III (non-corrosive), scores of 25 to less than 75 are EPA category II (non-corrosive), and scores 75 or greater are EPA Category I (corrosive). These scores are determined by an instrument that compares the relative opacity of bovine corneas exposed to test product for a set duration against a pre-exposure initial score. Formulations are preferably tested near the upper concentration limit of their active ingredient. Existing in-market laundry sanitizer products (Samples C and E from Table 8) are classified as EPA Category I for eye damage and therefore require Child Resistant Closures (CRC). Given that the largest non-water formulant is the active ingredient (in both examples), it was expected that higher levels of biocidal quat would likely drive the same result. Despite this, however, when one of the examples (E1) was tested on the OECD 437 method, an IVIS score of about 26 was received, which indicates no need for a child resistant closure. The formulations in Table 13 were also tested. Using the BKC at acidic pH yielded more favorable results (no need for child resistant closures) than the in market products (Samples C and E) which utilize blends of quaternary components at neutral or alkaline pH. Table 14 summarizes these results:

TABLE 13

| Abbreviation | E25 | | E26 | | E27 | |
|---|---|---|---|---|---|---|
| BKC (80%) | 4.13 | (3.3) | 6.95 | (5.56) | 7.8 | (6.24) |
| DO (30%) | 2.03 | (0.61) | 2.02 | (0.61) | 0 | |
| LO (30%) | 0 | | 0 | | 1.5 | (0.45) |
| PE | 1 | | 0.91 | | 0.5 | |
| PG | 0.60 | | 0.54 | | 0.5 | |
| HEC | 0.36 | | 0.35 | | 0.3 | |
| NaOH (50%) | 0.05 | (0.025) | 0.06 | (0.03) | 0.06 | (0.03) |

| CA | 0.85 | | 0.84 | | 0.85 |
|---|---|---|---|---|---|
| D | 0 | | 0 | | 0.0018 |
| F | 0 | | 0 | | 0.82 |
| H2O | 81.5182 | | 80.0182 | | |
| OPR2 | 0 | | 0 | | 0.26 |
| PQ6 | 1.03 | (0.5) | 1 | (0.5) | 0 |

| | | | | |
|---|---|---|---|---|
| PQ37 | 0 | 0 | 1.02 | (0.51) |

| EGHE | 1 | 1 | 0 |
|---|---|---|---|
| H2O | q.s. | q.s. | q.s. |

TABLE 14

| Sample | E1 | C | E | E23 | E24 | E25 |
|---|---|---|---|---|---|---|
| Corrosive to eyes? | No | Yes | Yes | No | No | No |

### Example 12—Long Lasting Fragrance Technology

One common challenge in developing fabric care products is delivering a fragrance/freshness benefit that lasts multiple weeks after drying. Since fragrance (free oils) contain volatile compounds, many products volatilize quickly and leave behind only a faint or negligible amount of scent. To overcome this phenomenon, many products in the fabric care industry rely on encapsulated fragrance technology that uses an outer shell to encompass a fragrance oil and release it after exposure to a source of friction.

E1 showed surprising results in a consumer testing scenario. E1 contains a fragrance comprising a profragrance aroma chemical and no encapsulated fragrances. E2 contains an encapsulated fragrance. Based on the publicly available ingredients list, A from Table 8 also contains an encapsulated fragrance. Based on the publicly available ingredients list, D from Table 8 does not contain an encapsulated fragrance. At an 8-week timepoint, 79% of panelists agreed with the statement “just about right” for the fragrance strength of E1, 76% agreed for E2, 78% agreed for A, and 66% agreed for D. D had higher scores for “somewhat too weak.” As a result, E1 was considered not statistically different when compared to E2 and A. E1 showed significantly higher fragrance intensity when compared to D.

These results highlight the benefit of including the profragrance technology in E1. The profragrance helps boost the fragrance strength even for extended durations without needing to rely on the standard industry practice of adding encaps to deliver a long-lasting fragrance.

### Example 13—Viscosity Versus Rheology

Suspending Encaps in a formulation and maintaining that suspension in at-rest conditions over extended periods of time is difficult. The order of addition is critical to increase physical stability. Sedimentation was observed when certain methods of manufacture were carried out. Homogeneity was maintained when using a different order of addition. The behavior of the fluid and physical characteristics of each set of batches was correlated by evaluating the zero shear viscosities determined using a rheometer. Higher zero shear viscosities dictate a higher physical stability of the formula. Measurements were extrapolated from a flow curve taken using a TA Waters Discovery Hybrid Rheometer with shear rates varying from 0.01 1/s to 1000 1/s at 21° C. over 600 seconds. A stainless steel 30 mm cup, 28 mm DIN standard concentric cylinder was used during the experiment.

With inadequate mixing speed, the addition of R93 after the formula's viscosity increases can lead to insufficient dispersion of the material thus affecting its suspension properties and leading to the sedimentation of the Encap. When R93 is added into water-thin liquid, it can disperse properly regardless of the mixing speed. The zero shear viscosity of E2 was ˜200 cps when R93 was added after the formula had been thickened. Alternately, when R93 was added prior to the formula thickening, the zero shear viscosity of E2 was ˜500+cps. Comparing the difference in zero shear viscosities, it is evident that an earlier addition of R93 provides a stable structure to allow for proper suspension of the Encap. Insufficient incorporation of R93 seen when adding it later in the manufacturing process impacted the physical stability of E2, leading to sedimentation of the Encap.

The difference in zero shear viscosities has been consistent with the physical stability observed and is summarized in Table 15, while the constant viscosity measurements are similar regardless of the homogeneity of the different batches.

TABLE 15

| | | Rheometer | | |
|---|---|---|---|---|
| | | Zero Sheer | Brookfield | |
| | Order of | Viscosity | Viscosity | Appearance |
| Formula | Addition | (cps) | (cps) | after 1 week |
| 500 g Batch | R93 after | 200-250 cps - | 168.6 | Sedimentation |
| | Viscosity | separation | | |
| | Increase | | | |
| 500 g Batch | R93 before | 500+ cps (736 | 205 | No |
| | Viscosity | cps) | | Sedimentation |
| | Increase | | | |
| 150 kg Batch | R93 after | 200-250 cps - | 137 | Sedimentation |
| | Viscosity | separation | | |
| | Increase | | | |
| 150 kg Batch | R93 before | 500+ cps (543 | 185.4 | No |
| | Viscosity | cps) | | Sedimentation |
| | Increase | | | |

Applicant believes these processes will scale up to 100,000 kg batches in the future because the rheology results predict similar success.

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

Based on the disclosures herein, below are non-limiting exemplary claims that may be pursued in non-provisional applications that claim the benefit of this application. These claims are presented for illustration purposes only and do not in any way limit the scope of the inventive concepts describe herein.

1. A liquid laundry product comprising a container comprising a liquid laundry composition, wherein the liquid laundry composition comprises:
approximately 2% wt to approximately 8% wt of a benzyl-substituted quaternary ammonium compound, and
scores 75 or less under Test 437 from Organisation for Economic Cooperation and Development (OECD) titled Bovine Corneal Opacity and Permeability Test Method for Identifying Ocular Corrosives and Severe Irritants.
   2. The liquid laundry product of claim 1, wherein the laundry composition is a biocide.
   3. The liquid laundry product of any of claim 1 or claim 2, wherein the laundry composition is a sanitizer.
   4. The liquid laundry product of any of the preceding claims, wherein the laundry composition is a conditioner.
   5. The liquid laundry product of any of the preceding claims, wherein the laundry composition is a fabric protector.
   6. The liquid laundry product of any of the preceding claims, wherein the laundry composition is a fabric protector and biocide.
   7. The liquid laundry product of any of the preceding claims, wherein the laundry composition is a fabric protector and sanitizer.
   8. The liquid laundry product of any of the preceding claims, wherein the laundry composition is a conditioner and biocide.
   9. The liquid laundry product of any of the preceding claims, wherein the laundry composition is a conditioner and sanitizer.
   10. The liquid laundry product of any of the preceding claims, wherein the laundry composition comprises only one benzyl-substituted quaternary ammonium compound.
   11. The liquid laundry product of any of the preceding claims, wherein the benzyl-substituted quaternary ammonium compound is substantially free of ester ligands.
   12. The liquid laundry product of any of the preceding claims, wherein the benzyl-substituted quaternary ammonium compound is substantially free of alkoxy ligands.
   13. The liquid laundry product of any of the preceding claims, wherein the benzyl-substituted quaternary ammonium compound comprises C12-18 alkyl dimethyl benzyl ammonium chloride.
   14. The liquid laundry product of any of the preceding claims, wherein the benzyl-substituted quaternary ammonium compound comprises C12-16 alkyl dimethyl benzyl ammonium chloride.
   15. The liquid laundry product of any of the preceding claims, wherein the composition comprises between approximately 2% wt and approximately 8% wt benzyl-substituted quaternary ammonium compound.
   16. The liquid laundry product of any of the preceding claims, wherein the composition comprises between approximately 2% wt and approximately 8% wt C12-18 alkyl dimethyl benzyl ammonium chloride.
   17. The liquid laundry product of any of the preceding claims, wherein the composition comprises between approximately 2% wt and approximately 8% wt C12-16 alkyl dimethyl benzyl ammonium chloride.
   18. The liquid laundry product of any of the preceding claims, wherein the composition comprises between approximately 2% wt and approximately 6% wt benzyl-substituted quaternary ammonium compound.
   19. The liquid laundry product of any of the preceding claims, wherein the composition comprises between approximately 2% wt and approximately 6% wt C12-18 alkyl dimethyl benzyl ammonium chloride.
   20. The liquid laundry product of any of the preceding claims, wherein the composition comprises between approximately 2% wt and approximately 6% wt C12-16 alkyl dimethyl benzyl ammonium chloride.
   21. The liquid laundry product of any of the preceding claims, wherein the composition comprises between approximately 3% wt and approximately 7% wt benzyl-substituted quaternary ammonium compound.
   22. The liquid laundry product of any of the preceding claims, wherein the composition comprises between approximately 3% wt and approximately 7% wt C12-18 alkyl dimethyl benzyl ammonium chloride.
   23. The liquid laundry product of any of the preceding claims, wherein the composition comprises between approximately 3% wt and approximately 7% wt C12-16 alkyl dimethyl benzyl ammonium chloride.
   24. The liquid laundry product of any of the preceding claims, wherein the composition comprises between approximately 3% wt and approximately 6% wt benzyl-substituted quaternary ammonium compound.
   25. The liquid laundry product of any of the preceding claims, wherein the composition comprises between approximately 3% wt and approximately 6% wt C12-18 alkyl dimethyl benzyl ammonium chloride.
   26. The liquid laundry product of any of the preceding claims, wherein the composition comprises between approximately 3% wt and approximately 6% wt C12-16 alkyl dimethyl benzyl ammonium chloride.
   27. The liquid laundry product of any of the preceding claims, wherein the composition comprises between approximately 3% wt and approximately 4% wt benzyl-substituted quaternary ammonium compound.
   28. The liquid laundry product of any of the preceding claims, wherein the composition comprises between approximately 3% wt and approximately 4% wt C12-18 alkyl dimethyl benzyl ammonium chloride.
   29. The liquid laundry product of any of the preceding claims, wherein the composition comprises between approximately 3% wt and approximately 4% wt C12-16 alkyl dimethyl benzyl ammonium chloride.
   30. The liquid laundry product of any of the preceding claims, wherein the composition comprises between approximately 0.3% wt to approximately 1.5% wt of an alkylamine oxide.
   31. The liquid laundry product of any of the preceding claims, wherein the composition comprises between approximately 0.3% wt to approximately 1.5% wt of a C10-14 alkylamine oxide.
   32. The liquid laundry product of claim 31, wherein the composition comprises between approximately 0.3% wt to approximately 1.5% wt of a lauramine oxide (C12).
   33. The liquid laundry product of claim 31, wherein the composition comprises between approximately 0.3% wt to approximately 1.5% wt of a decylamine oxide (C10).
   34. The liquid laundry product of any of the preceding claims, wherein the composition comprises between approximately 0.4% wt to approximately 1% wt of an alkylamine oxide.
   35. The liquid laundry product of any of the preceding claims, wherein the composition comprises between approximately 0.4% wt to approximately 1% wt of a C10-14 alkylamine oxide.
   36. The liquid laundry product of claim 35, wherein the composition comprises between approximately 0.4% wt to approximately 1% wt of a lauramine oxide.
   37. The liquid laundry product of claim 35, wherein the composition comprises between approximately 0.4% wt to approximately 1% wt of a decyl amine oxide.
   38. The liquid laundry product of any of the preceding claims, wherein the composition comprises between approximately 0.5% wt to approximately 1% wt of an alkylamine oxide.
   39. The liquid laundry product of any of the preceding claims, wherein the composition comprises between approximately 0.5% wt to approximately 1% wt of a C10-14 alkylamine oxide.
   40. The liquid laundry product of claim 39, wherein the composition comprises between approximately 0.5% wt to approximately 1% wt of a lauramine oxide.

41. The liquid laundry product of claim 39, wherein the composition comprises between approximately 0.5% wt to approximately 1% wt of a decyl amine oxide.

42. The liquid laundry product of any of the preceding claims, wherein the composition comprises between approximately 0.6% wt to approximately 1% wt of an alkylamine oxide.
43. The liquid laundry product of any of the preceding claims, wherein the composition comprises between approximately 0.6% wt to approximately 1% wt of a C10-14 alkylamine oxide.
44. The liquid laundry product of claim 43, wherein the composition comprises between approximately 0.6% wt to approximately 1% wt of a lauramine oxide.
45. The liquid laundry product of claim 43, wherein the composition comprises between approximately 0.6% wt to approximately 1% wt of a decyl amine oxide.
46. The liquid laundry product of any of the preceding claims, wherein the composition comprises approximately 0.4% wt to approximately 1% wt of phenoxyethanol.
47. The liquid laundry product of any of the preceding claims, wherein the composition comprises between approximately 0.45% wt to approximately 0.75% wt of phenoxyethanol.
48. The liquid laundry product of claim 46, wherein the composition comprises between approximately 0.5% wt to approximately 1% wt of phenoxyethanol.
49. The liquid laundry product of claim 46, wherein the composition comprises between approximately 0.8% wt to approximately 1% wt of phenoxyethanol.
50. The liquid laundry product of any of the preceding claims, wherein the composition further comprises water.
51. The liquid laundry product of any of the preceding claims, wherein the composition further comprises soft water.
52. The liquid laundry product any of the preceding claims, wherein the composition comprises water comprising less than 17 ppm calcium.
53. The liquid laundry product any of the preceding claims, wherein the composition comprises water comprising less than 5 ppm calcium.
54. The liquid laundry product any of the preceding claims, wherein the composition comprises water comprising less than 17 ppm magnesium.
55. The liquid laundry product any of the preceding claims, wherein the composition comprises water comprising less than 5 ppm magnesium.
56. The liquid laundry product of any of the preceding claims, wherein the composition further comprises approximately 80% wt to approximately 97.5% wt water.
57. The liquid laundry product of any of the preceding claims, wherein the composition further comprises approximately 85% wt to approximately 95% wt water.
58. The liquid laundry product of any of the preceding claims, wherein the composition is a liquid.
59. The liquid laundry product of any of the preceding claims, wherein the composition is a single-phase liquid.
60. The liquid laundry product of any of the preceding claims, wherein the composition is a clear single-phase liquid.
61. The liquid laundry product of any of the preceding claims, wherein the single-phase liquid composition is acidic.
62. The liquid laundry product of any of the preceding claims, wherein the composition has a pH ranging from approximately 2 to approximately 4.
63. The liquid laundry product of any of the preceding claims, wherein the composition has a pH ranging from approximately 2.5 to approximately 3.15.
64. The liquid laundry product of any of the preceding claims, wherein the composition further comprises a liquid ethoxyquat.
65. The liquid laundry product of any of the preceding claims, wherein the composition further comprises a non-polymeric alkoxy quaternary ammonium salt.
66. The liquid laundry product of any of the preceding claims, wherein the composition comprises between approximately 2% wt and approximately 5% wt liquid non-polymeric alkoxy quaternary ammonium salt.
67. The liquid laundry product of any of the preceding claims, wherein the composition comprises between approximately 3% wt and approximately 4% wt liquid non-polymeric alkoxy quaternary ammonium salt.
68. The liquid laundry product of any of claims 65 to 67, wherein the liquid non-polymeric alkoxy quaternary ammonium salt is N,N′-di(alkylcarboxyethyl)-N-hydroxyethyl-N-methylammonium sulfate.
69. The liquid laundry composition of any of claims 65 to 68, wherein the liquid non-polymeric alkoxy quaternary ammonium salt is a fabric protector.
70. The liquid laundry product of any of the preceding claims, wherein the composition further comprises a carrier solvent.
71. The liquid laundry product of claim 70, wherein the carrier solvent comprises methanediol, 1,2-propanediol, 1,3-propanediol, 1,2-butanediol, 1,3-butanediol, 1,4-butanediol, 2,3-butanediol, polyethyelene glycol, polypropylene glycol, glycerin, ethylene glycol mono hexyl ether, propylene glycol phenyl ether, water, or combinations thereof.
72. The liquid laundry product of claim 70 or 71, wherein the carrier solvent comprises 1,2-propanediol, 1,3-propanediol, glycerin, ethylene glycol mono hexyl ether, propylene glycol phenyl ether, water, or combinations thereof.
73. The liquid laundry product of any of the preceding claims, wherein the composition comprises between approximately 0.1% wt to approximately 2.5% wt of non-aqueous carrier solvent.
74. The liquid laundry product of any of the preceding claims, wherein the composition comprises between approximately 0.25% wt to approximately 2% wt of a non-aqueous carrier solvent.
75. The liquid laundry product of any one of claims 70 to 74, wherein the non-aqueous carrier solvent comprises ethylene glycol mono hexyl ether, propylene glycol phenyl ether, and combinations thereof.
76. The liquid laundry product of any one of claims 70 to 75, wherein the non-aqueous carrier solvent comprises ethylene glycol mono hexyl ether.
77. The liquid laundry product of any one of claims 70 to 75, wherein the non-aqueous carrier solvent comprises propylene glycol phenyl ether.
78. The liquid laundry product of any one of claims 70 to 74, wherein the non-aqueous carrier solvent comprises 1,2-propanediol, 1,3-propanediol, glycerin, or combinations thereof.
79. The liquid laundry product of any of the preceding claims, wherein the composition further comprises a cellulose based thickener.
80. The liquid laundry product of any of the preceding claims, wherein the composition comprises between approximately 0.1% wt and approximately 0.5% wt thickener.
81. The liquid laundry product of any of the preceding claims, wherein the composition comprises between approximately 0.25% wt and approximately 0.45% wt thickener.
82. The liquid laundry product of any one of claims 79 to 81, wherein the cellulose based thickener comprises carboxymethyl cellulose, hydroxyethylcellulose, hydropropylmethylcellulose, methylhydroxyethylcellulose, fermentation-derived cellulose, or combinations thereof.
83. The liquid laundry product of any one of claims 79 to 82, wherein the cellulose based thickener comprises hydroxyethylcellulose.
84. The liquid laundry product of any one of claims 79 to 82, wherein the cellulose based thickener comprises methylhydroxyethylcellulose.
85. The liquid laundry product of any one of claims 79 to 84, wherein the composition transforms from a single phase liquid to a colloid after addition of the thickener.
86. The liquid laundry product of any one of claims 79 to 85, wherein the composition exhibits an approximately 50% to 90% decrease in viscosity over approximately 2 years time, as measured after 60 seconds at 100 RPM using a LV62 spindle at ambient temperature.
87. The liquid laundry product of any one of claims 79 to 86, wherein the composition exhibits an approximately 65% to 85% decrease in viscosity over approximately 2 years time, as measured after 60 seconds at 100 RPM using a LV62 spindle at ambient temperature.
88. The liquid laundry product of any of the preceding claims, wherein the composition further comprises an opacifier.
89. The liquid laundry product of claim 88, wherein the opacifier comprises an opacifier blend of cocamidopropyl betaine, glycol distearate, and sodium benzoate.
90. The liquid laundry product of claim 88 or 89, wherein the opacifier blend is sold by Solvay under the tradename Miracare™ OPR2, previously known as Mackadet™ OPR2.
91. The liquid laundry product of any one of claims 88 to 90, wherein the composition comprises between approximately 0.05% wt to approximately 0.5% wt opacifier.
92. The liquid laundry product of any one of claims 88 to 91, wherein the composition further comprises a polymer to suspend the opacifier.
93. The liquid laundry product of claim 92, wherein the composition comprises between approximately 1% wt to approximately 3% wt polymer.
94. The liquid laundry product of claim 92 or 93, wherein the composition comprises between approximately 1.5% wt to approximately 2.5% wt polymer.
95. The liquid laundry product of any one of claims 92 to 94, wherein the polymer comprises poly(2-methacryloxyethyltrimethylammonium chloride).
96. The liquid laundry product of any one of claims 92 to 94, wherein the polymer comprises poly(diallylmethylammonium chloride).
97. The liquid laundry product of any of the preceding claims, wherein the composition further comprises a polymer to enhance microefficacy.
98. The liquid laundry product of claim 97, wherein the polymer is selected from the group consisting of poly(diallyldimethylammonium chloride) (PQ6) having a molecular weight <100 kDa (PQ6<100 kDa); PQ6 having a molecular weight ranging from 200 kDa to 300 kDa (PQ6 200-300 kDa); PQ6 having a molecular weight ranging from 400 kDa to 500 kDa (PQ6 400-500 kDa); copolymers of vinylpyrrolidone (VP) and quaternized vinylimidazole (QVI)(PQ16) having 5% wt VP and 95% wt QVI (PQ16 5VP-95QVI); PQ16 having 50% wt VP and 95% wt QVI (PQ16 50VP-50QVI); Poly(2-dimethylamino)ethyl methacrylate) methyl chloride quaternary salt (PQ37); 1-propanaminium, N,N,N-trimethyl-3-[(1-oxo-2-propenyl)amino] chloride, homopolymer (A1000); 1-dodecanaminium, N,N-dimethyl-N-[3-[(2-methyl-1-oxo-2-propen-1-yl)amino]propyl]-, chloride (1:1), polymer with sodium 2-methyl-2-[(1-oxo-2-propen-1-yl)amino]-1-propanesulfonate (1:1) and N,N,N-trimethyl-3-[(1-oxo-2-propen-1-yl)amino]-L propanaminium chloride (1:1) (C113); and combinations thereof.
99. The liquid laundry product of claim 97 or 98, wherein the polymer comprises PQ6<100 kDa, PQ6 200-300 kDa, PQ6 400-500 kDa, PQ16 5VP-95QVI, A1000, C113, or combinations thereof.
100. The liquid laundry product of any one of claims 97 to 99, wherein the polymer comprises PQ6<100 kDa, PQ6 200-300 kDa, or combinations thereof.
101. The liquid laundry product of any one of claims 97 to 100, wherein the polymer comprises PQ6<100 kDa.
102. The liquid laundry product of any one of claims 97 to 100, wherein the polymer comprises PQ6 200-300 kDa.
103. The liquid laundry product of any one of claims 97 to 99, wherein the polymer comprises PQ6 400-500 kDa.
104. The liquid laundry product of any one of claims 97 to 103, wherein the composition comprises between approximately 0.5% wt and approximately 3% wt PQ6.
105. The liquid laundry product of claim 97 or 98, wherein the polymer comprises PQ16 5VP-95QVI.
106. The liquid laundry product of any one of claims 97 to 99, wherein the polymer comprises PQ16 50VP-50QVI.
107. The liquid laundry product of claim 97 or 98, wherein the polymer comprises PQ37.
108. The liquid laundry product of any one of claims 97 to 99, wherein the polymer comprises A1000.
109. The liquid laundry product of any one of claims 97 to 99, wherein the polymer comprises C113.
110. The liquid laundry product of any of the preceding claims, wherein the composition is substantially free of a polymer selected from the group consisting of poly(acrylamide-co-diallyldimethylammonium chloride (PQ7), copolymers of vinylpyrrolidone and quaternized vinylimidazole having more vinylpyrrolidone units than quaternized vinylimidazole units (PQ16 70VP-30QVI), 2-pyrrolidinone, 1-ethenyl-polymer with N,N,N-trimethyl-3-[(2-methyl-1-oxo-2-propenyl)amino]-1-propanium chloride (PQ28), or combinations thereof.
111. The liquid laundry product of any of the preceding claims, wherein the composition further comprises enzymes.
112. The liquid laundry product of any of the preceding claims, wherein the composition further comprises a cellulase enzyme.
113. The liquid laundry product of any of the preceding claims, wherein the composition further comprises a phosphodiesterase enzyme.
114. The liquid laundry product of any of the preceding claims, wherein the composition further comprises a protease enzyme.
115. The liquid laundry product of any of the preceding claims, wherein the composition further comprises an amylase enzyme.
116. The liquid laundry product of any of the preceding claims, wherein the composition further comprises approximately 0.1% wt to approximately 4% wt enzyme.
117. The liquid laundry product of any of the preceding claims, wherein the composition further comprises approximately 0.1% wt to approximately 1% wt enzyme.
118. The liquid laundry product of any of the preceding claims, wherein the composition further comprises approximately 0.25% wt to approximately 0.75% wt enzyme.
119. The liquid laundry product of any of the preceding claims, wherein the composition is substantially free of betaine surfactants.
120. The liquid laundry product of any of the preceding claims, wherein the composition is substantially free of enzymes.
121. The liquid laundry product of any of the preceding claims, wherein the composition is substantially free of a copolymer of acrylamide and diallyldimethylammonium chloride.
122. The liquid laundry product of any of the preceding claims, wherein the composition is substantially free of an added electrolyte, such as sodium chloride.
123. The liquid laundry product of any of the preceding claims, wherein the composition is substantially free of chelant.
124. The liquid laundry product of any of the preceding claims, wherein the composition is substantially free of anionic surfactant.
125. The liquid laundry product of any of the preceding claims, wherein the composition is substantially free of alkanolamine, such as monoethanolamine, diethanolamine, triethanolamine, or combinations thereof.
126. The liquid laundry product of any of the preceding claims, wherein the composition is substantially free of glycol ether.
127. The liquid laundry product of any of the preceding claims, wherein the composition is substantially free of peroxide.
128. The liquid laundry product of any of the preceding claims, wherein the composition is substantially free of bisguanide.
129. The liquid laundry product of any of the preceding claims, wherein the composition is substantially free of added alcohol.
130. The liquid laundry product of any of the preceding claims, wherein the composition is substantially free of added ethanol.
131. The liquid laundry product of any of the preceding claims, wherein the composition is substantially free of a copolymer of vinylpyrrolidone and quaternized vinylimidazole.
132. The liquid laundry product of any of the preceding claims, wherein the composition is substantially free of an unsaturated fatty alcohol.
133. The liquid laundry product of any of the preceding claims, wherein the composition comprises between approximately 1% wt and approximately 3% wt of ethylene glycol monohexyl ether.
134. The liquid laundry product of any of the preceding claims, wherein the composition further comprises a fragrance.
135. The liquid laundry product of any of the preceding claims, wherein the composition further comprises between approximately 0.1% wt to approximately 1.5% wt fragrance.
136. The liquid laundry product of any of the preceding claims, wherein the composition further comprises between approximately 0.5% wt to approximately 1.25% wt fragrance.
137. The liquid laundry product of any of the preceding claims, wherein the composition further comprises between approximately 0.7% wt to approximately 1% wt fragrance.
138. The liquid laundry product of any one of claims 134 to 137, wherein the fragrance comprises more bottom notes than top notes.
139. The liquid laundry composition of any one of claims 134 to 138, wherein the fragrance further comprises a pro-fragrance.
140. The liquid laundry product of any of the preceding claims, wherein the product further comprises an encapsulated fragrance.
141. The liquid laundry product of any of the preceding claims, the container comprising a bottle containing the liquid laundry composition and a removable cap which mates with and seals the bottle to contain the composition therein in a leak-proof manner, wherein the cap is not a child resistant closure.
142. The liquid laundry product of claim 141, wherein the removable cap is also a dosing cap.
143. The liquid laundry product of claim 142, wherein an interior of the removable cap contains one or more lines to indicate one or more dosing volumes of the liquid laundry composition.
144. A method of sanitizing and conditioning fabrics, the method comprising a dilution step in which water and the liquid laundry composition disclosed in any of claims 1 to 143 are mixed to produce a diluted composition and contacting a fabric to be treated with the diluted composition.
145. The method of claim 144, wherein the dilution step comprises adding 125 mL to 300 mL of the liquid laundry composition disclosed in any of claims 1 to 105 to the rinse aid dispenser or directly to the rinse cycle of a top loader (47 L H2O).
146. The method of claim 144, wherein the dilution step comprises adding 75 mL to 180 mL of the liquid laundry composition disclosed in any of claims 1 to 105 to the rinse aid dispenser or directly to the rinse cycle of a top loader (39 L H2O).
147. The method of claim 144, wherein the dilution step comprises adding 250 mL to 350 mL of the liquid laundry composition disclosed in any of claims 1 to 105 to the rinse aid dispenser or directly to the rinse cycle of a top loader (71 L H2O).
148. The method of claim 144, wherein the dilution step comprises adding 300 mL to 400 mL of the liquid laundry composition disclosed in any of claims 1 to 105 to the rinse aid dispenser or directly to the rinse cycle of a top loader (89 L H2O).
149. The method of claim 144, wherein the dilution step comprises adding 25 mL to 100 mL of the liquid laundry composition disclosed in any of claims 1 to 105 to the rinse aid dispenser of a front loader (17 L H2O).
150. The method of claim 144, wherein the dilution step comprises adding 50 mL to 100 mL of the liquid laundry composition disclosed in any of claims 1 to 105 to one gallon water in a bucket for pre-soak.

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1) A liquid laundry product comprising a container comprising a liquid laundry composition, wherein the liquid laundry composition comprises:
approximately 2% wt to approximately 8% wt of a benzyl-substituted quaternary ammonium compound, and
scores 75 or less under Test 437 from Organisation for Economic Cooperation and Development (OECD) titled Bovine Corneal Opacity and Permeability Test Method for Identifying Ocular Corrosives and Severe Irritants.

2) The liquid laundry product of claim 1, wherein the liquid laundry composition comprises approximately 2% wt to approximately 6% wt of the benzyl-substituted quaternary ammonium compound.

3) The liquid laundry product of claim 2, wherein the liquid laundry composition comprises approximately 2% wt to approximately 4% wt of the benzyl-substituted quaternary ammonium compound.

4) The liquid laundry product of claim 1, wherein the benzyl-substituted quaternary ammonium compound is C12-18 alkyl dimethyl benzyl ammonium chloride.

5) The liquid laundry product of claim 1, wherein the liquid laundry composition is substantially free of any additional quaternary ammonium compounds.

6) The liquid laundry product of claim 1, wherein the liquid laundry composition further comprises approximately 0.3% wt to approximately 1.5% wt of an alkylamine oxide and approximately 0.4% wt to approximately 1% wt of phenoxyethanol.

7) The liquid laundry product of claim 3, wherein the liquid laundry composition further comprises approximately 0.5% wt to approximately 1% wt of an alkylamine oxide and approximately 0.8% wt to approximately 1% wt of phenoxyethanol.

8) The liquid laundry product of claim 6, wherein the alkylamine oxide is lauramine oxide or decylamine oxide.

9) The liquid laundry product of claim 1, wherein the liquid laundry composition further comprises approximately 0.5% wt to approximately 1% citric acid.

10) The liquid laundry product of claim 1, wherein the liquid laundry composition further comprises between approximately 2% wt and approximately 5% wt of a liquid ethoxyquat.

11) The liquid laundry product of claim 10, wherein the liquid ethoxyquat is N,N′-di(alkylcarboxyethyl)-N-hydroxyethyl-N-methylammonium sulfate.

12) The liquid laundry product of claim 1, wherein the liquid laundry composition further comprises approximately 0.1% wt to approximately 1.5% wt. fragrance, wherein the fragrance comprises a profragrance.

13) The liquid laundry product of claim 1, wherein the liquid laundry composition further comprises an encapsulated fragrance.

14) The liquid laundry product of claim 13, wherein the encapsulated fragrance has a polyacrylate or biodegradable shell.

15) The liquid laundry product of claim 13, wherein the liquid laundry composition further comprises a fermentation derived cellulose.

16) The liquid laundry product of claim 1, wherein the liquid laundry composition is a clear single-phase liquid having a pH ranging from approximately 2 to approximately 4.

17) The liquid laundry product of claim 1, wherein the liquid laundry product does not include child-resistant packaging.

18) The liquid laundry product of claim 17, wherein the container does not comprise a child-resistant cap when sold in the US.

19) The liquid laundry product of claim 1, wherein the liquid laundry composition achieves equal to or greater than a 3 log₁₀ reduction of Staphylococcus aureus and Klebsiella pneumoniae both (a) on a test fabric and (b) in wash water after a contact time of 25 minutes at a temperature of 20° C.

20) A method of manufacturing the liquid laundry product of claim 15, the method comprising:
adding water to a mixer,
adding the fermentation derived cellulose to the water and mixing for approximately 10 to approximately 30 minutes to form a mixture,
adding a cellulose thickener to the mixture and mixing to form a homogeneous mixture,
adjusting the pH to 10 or above and mixing for approximately 30 to approximately 90 minutes,
adjusting the pH to 4 or below to form an acidic homogeneous mixture;
adding the encapsulated fragrance to the acidic homogeneous mixture to form an encap-containing acidic homogeneous thickened mixture,
independently adding and mixing until homogeneous the benzyl-substituted quaternary ammonium compound and any additional ingredients to form the liquid laundry composition.
